(19) United States
(12) Patent Application Publication
(10) Pub. No.: US 2013/0048752 A1
(43) Pub. Date: Feb. 28, 2013

(54) SYSTEMS AND METHODS FOR ARRANGING, MAINTAINING, OR OPERATING HELIOSTATS IN A SOLAR FIELD

(71) Applicants: Yoel Gilon, Jerusalem (IL); Gil Kroyzer, Jerusalem (IL); Maro Van Dyke, Beit Shemesh (IL)

(72) Inventors: Yoel Gilon, Jerusalem (IL); Gil Kroyzer, Jerusalem (IL); Maro Van Dyke, Beit Shemesh (IL)

(21) Appl. No.: 13/580,173

(22) PCT Filed: Feb. 25, 2011
(86) PCT No.: PCT/US2011/026273

§ 371 Date: Nov. 5, 2012

Related U.S. Application Data
(60) Provisional application No. 61/307,994, filed on Feb. 25, 2010.
(60) Provisional application No. 61/355,271, filed on Jun. 16, 2010.
(60) Provisional application No. 61/378,382, filed on Aug. 30, 2010.
(60) Provisional application No. 61/380,237, filed on Sep. 5, 2010.

(51) Int. Cl. B08B 3/02; B08B 1/00; B08B 13/00

(52) U.S. Cl. 239/165; 239/172; 134/172; 15/102

(57) ABSTRACT

A maintenance vehicle for heliostats as well as heliostats within a solar field of a solar tower system can be controlled to reduce the likelihood of damage to an indigenous animal or its habitat. At least some of the heliostats can be arranged and operated in such a manner that the maintenance vehicle can pass through the solar field along conditional pathways. The arrangement and control of the heliostats to allow access to heliostats by a maintenance vehicle can enable different heliostat patterns as compared with conventional arrangements. In particular, heliostats in one section of the solar field can be arranged in a more ordered and high density pattern while heliostats in another section of the solar field can be arranged in a more disordered pattern. The density and arrangement of heliostats in various sections of the field can be optimized to improve and/or maximize solar energy production and/or revenue generation.

### CROSS-REFERENCE TO RELATED APPLICATIONS

The present application claims the benefit of U.S. Provisional Application No. 61/307,994, filed Feb. 25, 2010, U.S. Provisional Application No. 61/355,271, filed Jun. 16, 2010, U.S. Provisional Application No. 61/378,382, filed Aug. 30, 2010, and U.S. Provisional Application No. 61/380,237, filed Sep. 5, 2010, all of which are hereby incorporated by reference herein in their entirety.

### FIELD

The present disclosure relates generally to solar energy systems, and, more particularly, to systems and methods for constructing and/or arranging heliostats within a solar field. The disclosure also relates to systems and methods for maintaining and/or operating the heliostats of the solar field.

### SUMMARY

Embodiments of the present disclosure relate generally to systems, methods, and devices for maintaining and/or operating a solar field of a solar power system. A maintenance vehicle can be navigated through the solar field and/or heliostats operated in a specific manner to effect maintenance (such as cleaning, repair, or replacement) of certain heliostats. Control of the maintenance vehicle and/or operation of the heliostats can be such that the likelihood of damage to an indigenous animal, such as a desert tortoise, and/or its habitat is reduced and/or minimized. Thus, the co-existence of the solar field with threatened and/or endangered species or animals covered by a conservation plan can be facilitated. The maintenance vehicle can move through the solar field on permanent or conditional pathways within the solar field. Heliostats may be controlled to allow the maintenance vehicle to proceed along these conditional pathways.

Heliostats in one section of the solar field, e.g., close to the solar tower, can be arranged in a more ordered and high density pattern while heliostats in another section of the solar field, e.g., far from the solar tower, can be arranged in a more disordered pattern. Access to the heliostats in either the ordered or disordered pattern sections can thus be made available by controlling certain heliostats to open conditional pathways in the solar field for a maintenance vehicle. The density and arrangement of heliostats in various sections of the field can be optimized to improve and/or maximize solar energy production and/or revenue generation. The density/arrangement of the heliostats may be chosen without regard to symmetry with respect to cardinal directions.

In embodiments, a maintenance vehicle for cleaning heliostats in a solar field can include a main body, a translation system, and one or more cleaning modules. The translation system can be constructed to move the main body through the solar field. Each cleaning module can include at least one cleaning tool. In addition, each cleaning module can be configured to position each cleaning toll proximal to a corresponding mirror surface of one of the heliostats for cleaning.

In embodiments, a method of cleaning heliostats in a solar field with a maintenance vehicle can include determining no-drive zones within a solar field based on at least one of predicted animal movement, detected animal movement, predicted animal location, detected animal location, predicted animal habitat location, and detected animal habitat location. The method can also include moving the maintenance vehicle from a first location to a second location in the solar field while avoiding the determined no-drive zones.

In embodiments, a method of maintaining or operating heliostats deployed in a solar field can include electronically detecting or predicting presence or movement of a non-domestic animal within the solar field and effecting at least one solar field operation according to the detected or predicted animal presence or movement. The at least one solar field operation can include cleaning heliostats in the solar field in an order and/or at a rate according to the detected or predicted presence or movement, aiming the heliostats according to the detected or predicted animal movements, and operating a solar field vehicle within the solar field according to the detected or predicted presence or movement.

In embodiments, a method of maintaining or operating heliostats deployed in a solar field can include electronically monitoring the movements of a non-domestic animal over a period of time to determine at least one temporal movement pattern for the non-domestic animal, determining at least one current time parameter selected from the group including a current time of day and a current season of the year, predicting at least one of current location of the non-domestic animal and a confidence level of a prediction of a current location of the non-domestic animal, and effecting at least one solar field operation in accordance with the prediction. The at least one temporal movement pattern can include a daily movement pattern time of day describing trends of movement of the non-domestic animal within the solar field as a function of time of day, and a seasonal movement pattern time of day describing animal movement trends as a function of time of year. The at least one solar field operation can include cleaning heliostats in the solar field in an order and/or at a rate according to the detected or predicted presence or movement, aiming the heliostats according to the detected or predicted animal movements, and operating a solar field vehicle within the solar field according to the detected or predicted presence or movement.

In embodiments, a solar system can include a plurality of heliostats configured to re-direct insolation toward a target deployed in a solar field and a robotic heliostat cleaner configured to clean mirrors of the heliostats at different locations in the solar field. The robotic heliostat cleaner can include control circuitry that causes the robotic heliostat cleaner to travel in a manner that is contingent upon detected or predicted movements of a non-domestic animal within the solar field.

In embodiments, a method of maintaining or operating heliostats deployed in a solar field can include receiving location data indicating locations of animal within a heliostat field, and directing movement of a robotic maintenance vehicle responsively to the location data. The maintenance vehicle may be configured to perform maintenance operations on heliostats of the solar field.

In embodiments, a cleaning system for heliostats can include a wheeled maneuverable truck, a controller, a pivoting support, and a cleaning effecter apparatus. The controller can be configured to control the truck for maneuvering throughout a field of heliostats responsively to control commands. The pivoting support can carry a longitudinal member with an axis extensible horizontally and configured to hold the cleaning effecter apparatus at various positions remote from the truck. The cleaning effecter apparatus can be configured to reach downwardly to clean horizontally-oriented and upwardly-facing surfaces of multiple heliostats.

In embodiments, an apparatus and/or a system may be configured to perform any of the methods disclosed herein.

In embodiments, a system, device, or method can include a vehicle or truck, or use thereof. The vehicle or truck can carry a mechanical deflector configured to move animals away from the wheels of the vehicle or truck, or, for method claims, employs the deflector to deflect animals away from the wheels of the vehicle or truck.

Objects and advantages of embodiments of the present disclosure will become apparent from the following description when considered in conjunction with the accompanying drawings.

### BRIEF DESCRIPTION OF THE DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements.

FIG. 1 is a schematic diagram illustrating concepts of a solar energy receiver mounted on a tower, according to one or more embodiments of the disclosed subject matter.

FIG. 2 is a schematic diagram illustrating an aerial view of a solar field of heliostats surrounding a solar energy tower, according to one or more embodiments of the disclosed subject matter.

FIG. 3A is a schematic diagram showing an elevation view of a heliostat cleaning vehicle in a portion of a field of heliostats, according to one or more embodiments of the disclosed subject matter.

FIG. 3B is a close-up view of a cleaning tool interacting with a heliostat mirror in a field of heliostats, according to one or more embodiments of the disclosed subject matter.

FIG. 3C is a close-up view of another cleaning tool interacting with a heliostat mirror in a field of heliostats, according to one or more embodiments of the disclosed subject matter.

FIG. 4 is a schematic diagram showing an aerial view of a field of heliostats with designated drive zones, according to one or more embodiments of the disclosed subject matter.

FIG. 5 is a schematic diagram showing an elevation view of a heliostat with a mirror at different orientations, according to one or more embodiments of the disclosed subject matter.

FIG. 6 is a schematic diagram of a control system for maintaining and/or operating heliostats in a solar field, according to one or more embodiments of the disclosed subject matter.

FIG. 7 is a schematic diagram showing an aerial view of a section of a solar field with a cleaning vehicle therein, according to one or more embodiments of the disclosed subject matter.

FIG. 8 is a schematic diagram showing an aerial view of an animal's movement within a section of a solar field, according to one or more embodiments of the disclosed subject matter.

FIG. 9 is a schematic diagram showing an elevation view of a heliostat cleaning vehicle in a portion of a field of heliostats, according to one or more embodiments of the disclosed subject matter

FIG. 10 is a schematic diagram showing an aerial view of a section of a solar field with heliostats at various orientations and progression of cleaning vehicles through the solar field, according to one or more embodiments of the disclosed subject matter.

FIG. 11 is a schematic diagram showing an aerial view of a section of a solar field with heliostats at various orientations and progression of different sized cleaning vehicles through the solar field, according to one or more embodiments of the disclosed subject matter.

FIG. 12 is a diagram showing an aerial view of a section of a solar field and a pair of cleaning vehicles in the solar field, according to one or more embodiments of the disclosed subject matter.

FIG. 13 is a diagram showing the cleaning vehicles in the solar field of FIG. 12 at a later time, according to one or more embodiments of the disclosed subject matter.

FIG. 14 is a view of a portion of the solar field from a height of the tower with a heliostat cleaning vehicle in the field, according to one or more embodiments of the disclosed subject matter.

FIGS. 15-21 are isometric views of a portion of the solar field showing a cleaning vehicle moving through a conditional pathway and cleaning heliostats in the solar field, according to one or more embodiments of the disclosed subject matter.

FIG. 22 is a schematic diagram showing an aerial view of a solar field with different heliostat layouts in different portions of the solar field, according to one or more embodiments of the disclosed subject matter.

FIG. 23 is a schematic diagram showing a close-up aerial view of a portion of the solar field showing a first heliostat layout pattern in the outer portion and a second heliostat layout pattern in the inner portion, according to one or more embodiments of the disclosed subject matter.

FIG. 24 is a schematic diagram showing an aerial view of a solar field with sample locations identified of heliostat densities for Table 2, according to one or more embodiments of the disclosed subject matter.

FIGS. 25-30 are schematic diagrams showing aerial views of a solar field with various locations identified for comparison, according to one or more embodiments of the disclosed subject matter.

FIGS. 31-32 are graphs showing the number of heliostats as a function of distance to the nearest neighboring heliostat, according to one or more embodiments of the disclosed subject matter.

FIGS. 33-35 are schematic diagrams showing aerial views of multiple tower and solar field arrangements, according to one or more embodiments of the disclosed subject matter.

FIG. 36 is a diagram of a single mirror heliostat, according to one or more embodiments of the disclosed subject matter.

FIG. 37 is a picture of a dual mirror heliostat, according to one or more embodiments of the disclosed subject matter.

FIGS. 38-39 are schematic diagrams showing aerial views of solar fields showing an ordered arrangement of heliostat, according to one or more embodiments of the disclosed subject matter.

FIG. 40 is a schematic diagram showing an aerial view of a solar field with various sections having different heliostat arrangements, according to one or more embodiments of the disclosed subject matter.

FIG. 41 is a schematic diagram showing a close-up aerial view of a solar field close to the tower, according to one or more embodiments of the disclosed subject matter.

FIGS. 42-43 are schematic diagrams showing close-up aerial views of a northeast section of first and second solar fields, respectively, according to one or more embodiments of the disclosed subject matter.

FIGS. 44-45 are schematic diagrams showing close-up aerial views of a northwest section of first and second solar fields, respectively, according to one or more embodiments of the disclosed subject matter.

FIGS. 46-47 are schematic diagrams showing close-up aerial views of a southeast section of first and second solar fields, respectively, according to one or more embodiments of the disclosed subject matter.

FIGS. 48-49 are schematic diagrams showing close-up aerial views of a southwest section of first and second solar fields, respectively, according to one or more embodiments of the disclosed subject matter.

FIG. 50 is an elevation view of a heliostat with different mirror arrangements for different times of day, according to one or more embodiments of the disclosed subject matter.

FIG. 51 is an elevation view of a pair of heliostats at a first spacing resulting in partial shading of one of the heliostats, according to one or more embodiments of the disclosed subject matter.

FIG. 52 is an elevation view of a pair of heliostats at a second spacing that does not resulting in shading, according to one or more embodiments of the disclosed subject matter.

FIGS. 53-54 show northern views of the inner portion and outer portion, respectively, of a solar field from the top of the tower, according to one or more embodiments of the disclosed subject matter.

FIGS. 55-56 show southern views of the inner portion and outer portion, respectively, of a solar field from the top of the tower, according to one or more embodiments of the disclosed subject matter.

FIGS. 57-58 are schematic diagrams showing aerial views of a portion of first and second solar fields, according to one or more embodiments of the disclosed subject matter.

FIG. 59 shows a configuration for a maintenance vehicle that moves over a single row of heliostats.

FIG. 60 shows an articulating vehicle that maneuvers between heliostats to wash them.

### DETAILED DESCRIPTION

Embodiments of the present disclosure relate generally to systems, methods, and devices for maintaining and/or operating a solar field of a solar power system. In particular, the disclosure relates to power plant magnitude systems rather than pilot systems. For example, the peak flux power level of aggregate flux to the tower and/or the target(s) is at least 5 megawatts, at least 10 megawatts, at least 20 megawatts, at least 50 megawatts, at least 100 megawatts, at least 250 megawatts, or at last 500 megawatts.

A maintenance vehicle can be navigated through the solar field and/or heliostats operated in a specific manner to effect cleaning of the heliostats. Control of the maintenance vehicle and/or operation of the heliostats can be such that the likelihood of damage to an indigenous animal, such as a desert tortoise, and/or its habitat is reduced and/or minimized. Thus, the co-existence of the solar field with threatened and/or endangered species or animals covered by a conservation plan can be facilitated. Although discussed in connection with the desert tortoise, the embodiments can be used to be responsive to the growth of vegetation which may move or die and reappear in different locations.

The maintenance vehicle can move through the solar field on permanent pathways within the solar field. Additionally or alternatively, at least some of the heliostats can be arranged and controlled in such a manner that the maintenance vehicle can pass through the solar field along conditional pathways, i.e., pathways via which a particular maintenance vehicle would normally not be able to pass when the heliostats are oriented to aim at a receiver in a solar tower.

The arrangement and control of the heliostats to allow access to heliostats by a maintenance vehicle moving through the solar field can enable different heliostat patterns as compared with conventional arrangements. In particular, heliostats in one section of the solar field, e.g., close to the solar tower, can be arranged in a more ordered and high density pattern while heliostats in another section of the solar field, e.g., far from the solar tower, can be arranged in a more disordered pattern. Access to the heliostats in either the ordered or disordered pattern sections can thus be made available by controlling certain heliostats to open conditional pathways in the solar field for a maintenance vehicle. The density and arrangement of heliostats in various sections of the field can be optimized to improve and/or maximize solar energy production and/or revenue generation. The density/arrangement of the heliostats may be chosen without regard to symmetry with respect to cardinal directions.

Throughout the present disclosure, various examples are described for maintaining or operating the solar field in a manner that facilitates co-existence with the one or more animals. For example, the solar field can located in the Mojave Desert in the southwestern United States, and the animal can be the desert tortoise (i.e., Gopherus agassizii). While certain examples presented herein may relate to the particular case of the desert tortoise, the teachings of the present disclosure are applicable to facilitating the co-existence between the solar field and animals other than desert tortoises according to one or more contemplated embodiments.

One or more of the following features can be used to facilitate the co-existence between a solar field and an animal, such as the desert tortoise: (i) measures are taken to minimize or eliminate the likelihood of damage to an animal or its habitat by a maintenance vehicle used for heliostat cleaning or maintenance even if one or more of these measures reduce the efficiency of the solar power system; (ii) the maintenance vehicles are operated in a manner so even in the ‘worst case’ an overwhelming majority of the field (e.g., at least 95% or 99% or 99.5% of the field) is designated as a “no-drive” zone where motor vehicles are not permitted to operate and/or physically constrained from operating; (iii) the solar field includes a plurality of heliostats (for example, at least hundreds or thousands of heliostats) deployed such that the mirrors of the heliostats are supported by a relatively thin pole and are situated high enough to allow free passage of most desert animals underneath; (iv) the area of ground disturbed when installing the thin-pole-mounted heliostats is minimal, thereby minimizing the impact upon wildlife in the region; and (v) the mirrors of the heliostats are large enough to provide shade relief to animals during the daytime.

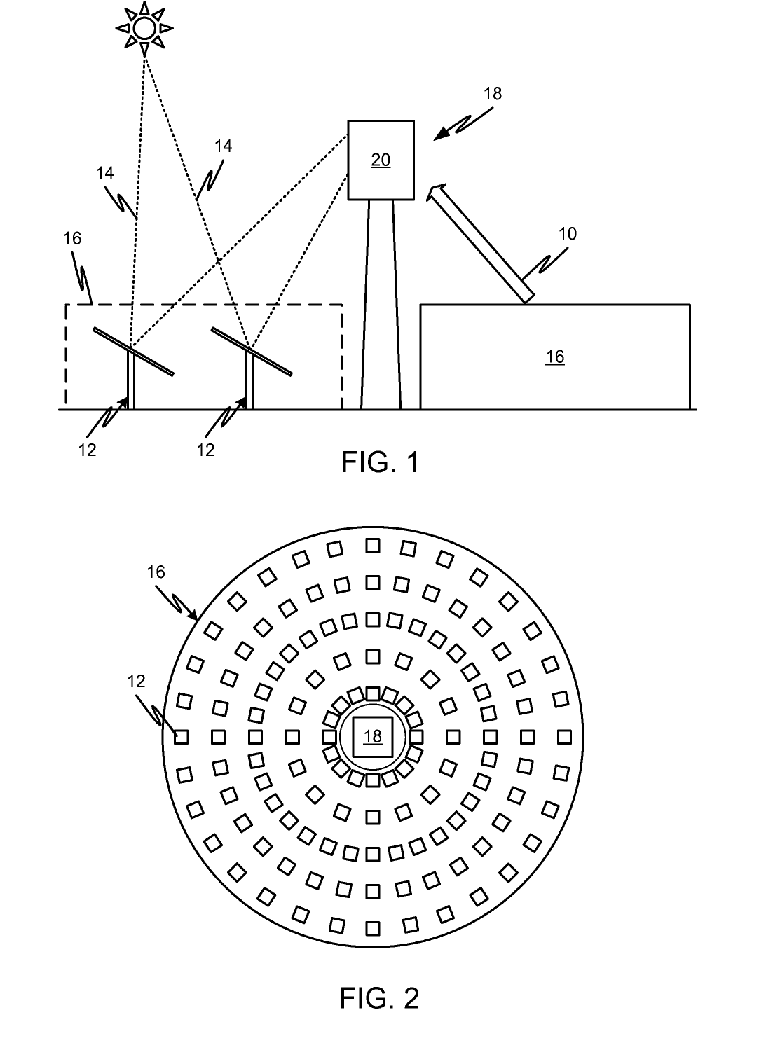

Referring now to FIG. 1, an illustration of a solar tower system is shown. The solar tower system can be configured, for example, to generate solar steam and/or to heat a fluid, such as a molten salt or a gas. The system can include a solar tower 18 which receives reflected focused sunlight 10 from a solar field 16 of individual heliostats 12 (only two are illustrated although an actual field may include thousands of heliostats 12). A solar energy receiver 20 can be mounted on the solar tower 18. Solar energy receiver 20 can include one or more separate receivers, for example, arranged at different heights or positions and/or serving different functions. The solar receiver 20 may be configured to heat water and/or steam and/or supercritical steam using insolation 14 reflected by the heliostats 12 onto receiver 20. For example, solar tower 18 may be at least 25 meters tall, at least 50 meters tall, at least 75 meters tall, or even taller. Only certain components have been illustrated in FIG. 1 for clarity and discussion. Physical embodiments of a solar tower system can include, for example, additional optical elements, control systems, sensors, pipelines, generators, and/or turbines, not shown in FIG. 1.

In an embodiment, a secondary reflector can receive the reflected insolation 10 from the heliostats 12. The secondary reflector can then reflect the insolation downward to a receiver located at or nearer to ground level. In embodiments, two or more solar towers 18 can be provided in a single solar field 16 or in respective solar fields 16. Each tower 18 can be associated with a respective solar system receiver, for example, a solar system steam receiver. In an embodiment, at any given time, a given heliostat may be directed to a solar receiver of any one of the towers.

In an embodiment, more than one solar receiver 20 can be mounted in tower 18. The aim of the heliostat may be adjusted to move the centroid of a reflected beam 10 projected at the tower 18 from one of the solar receivers in the tower 18 to another of the solar receivers in the same tower. Solar receivers 20 can include any combination of steam generators, steam superheaters, steam reheaters, photovoltaic panels, molten salt receivers, air receivers, helium receivers, particle receivers, or any other receiver configured to convert solar energy to electricity or heat.

FIG. 2 is a simplified aerial view of an embodiment of a solar energy system including a field 16 of individual heliostats 12. It is noted that this view has not been drawn to scale and has been simplified for clarity. Note that the heliostats may be arranged in a radially symmetric pattern with heliostats arranged along concentric pathways with respect to the tower 18. In embodiments, the heliostat mirrors can be periodically cleaned. Alternatively or additionally, one or more additional maintenance operations, such as heliostat repair or replacement) can be carried out on a one-by-one basis to most or all mirrors in the field of heliostats.

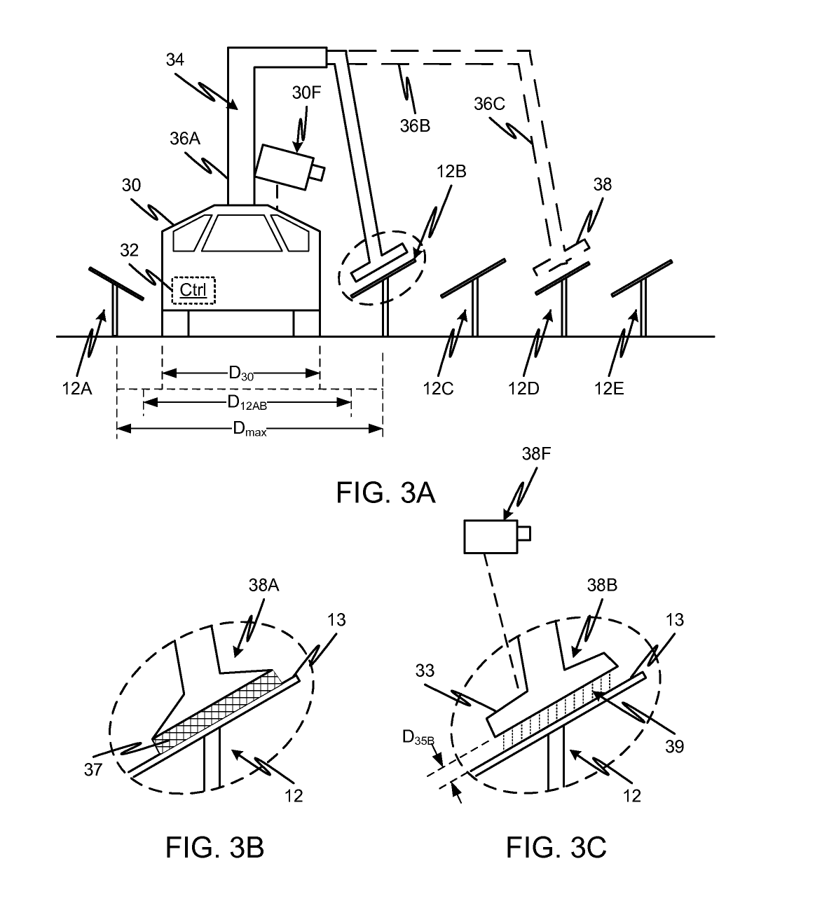

Towards this end and referring to FIG. 3A, a maintenance vehicle 30 may be provided in order to provide access to each heliostat 12 or a portion thereof, such as the reflecting surface of the mirror 13. Maintenance vehicle 30 can be an automated robotic vehicle, operated by a human driver in the vehicle 30, or operated by a human driver remote from the vehicle 30 (i.e., by remote control). To that end, a controller 32 can be included on board with the maintenance vehicle 30 to enable remote and/or robotic control.

The maintenance vehicle 30 can proceed along a drive path between heliostats 12A, 12B, which are sufficiently spaced apart to allow the vehicle 30 to pass. For example, the maintenance vehicle 30 can have a maximum width D₃₀ that is less than a distance between the heliostats 12A, 12B. The heliostats 12A, 12B may be sufficiently spaced apart that even when angled or aiming at the receiver, the distance D_{12AB} between the outermost parts of the heliostats 12A, 12B is still greater than the width D₃₀ of the vehicle 30 to allow the vehicle 30 to pass. Alternatively, the heliostats 12A, 12B may be arranged closer together such that outermost parts of the heliostats interfere with the vehicle 30. In order to thus let the vehicle 30 pass, the mirrors of the heliostats 12A, 12B can be controlled to move to a horizontal position, such that a distance Dₘₐₓ between the horizontal mirrors is greater than the width D₃₀ of the vehicle.

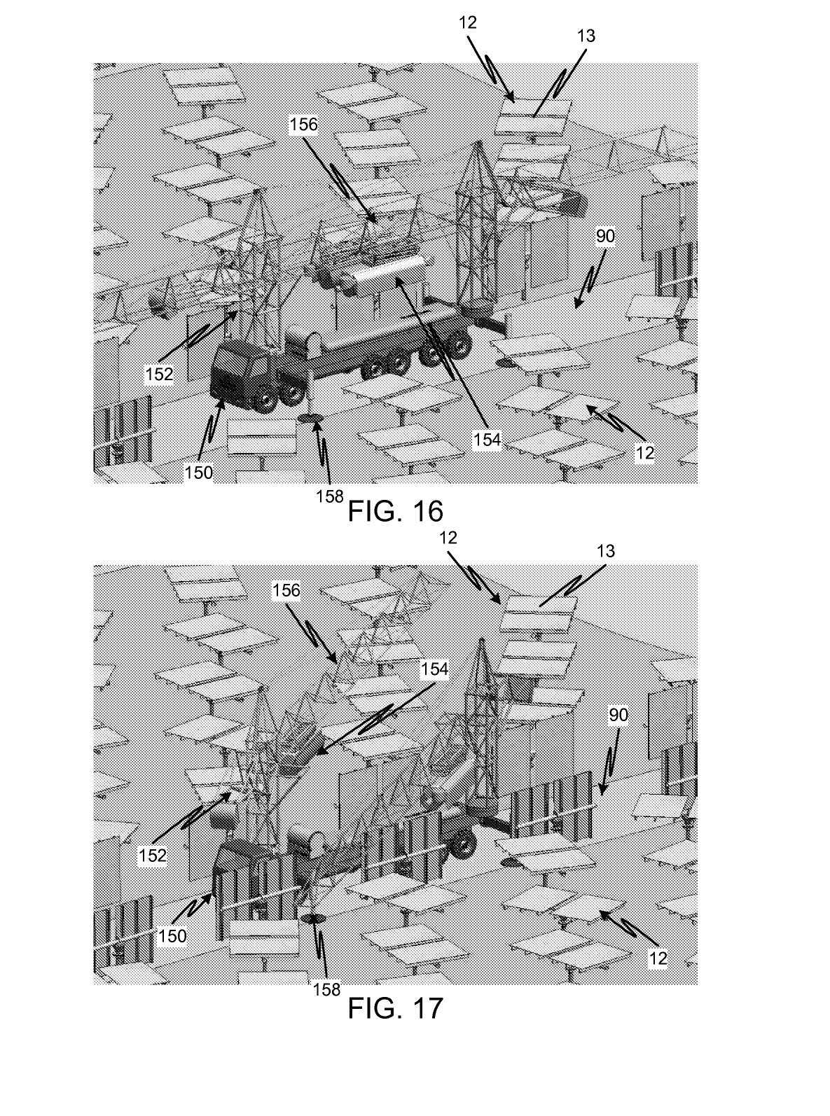

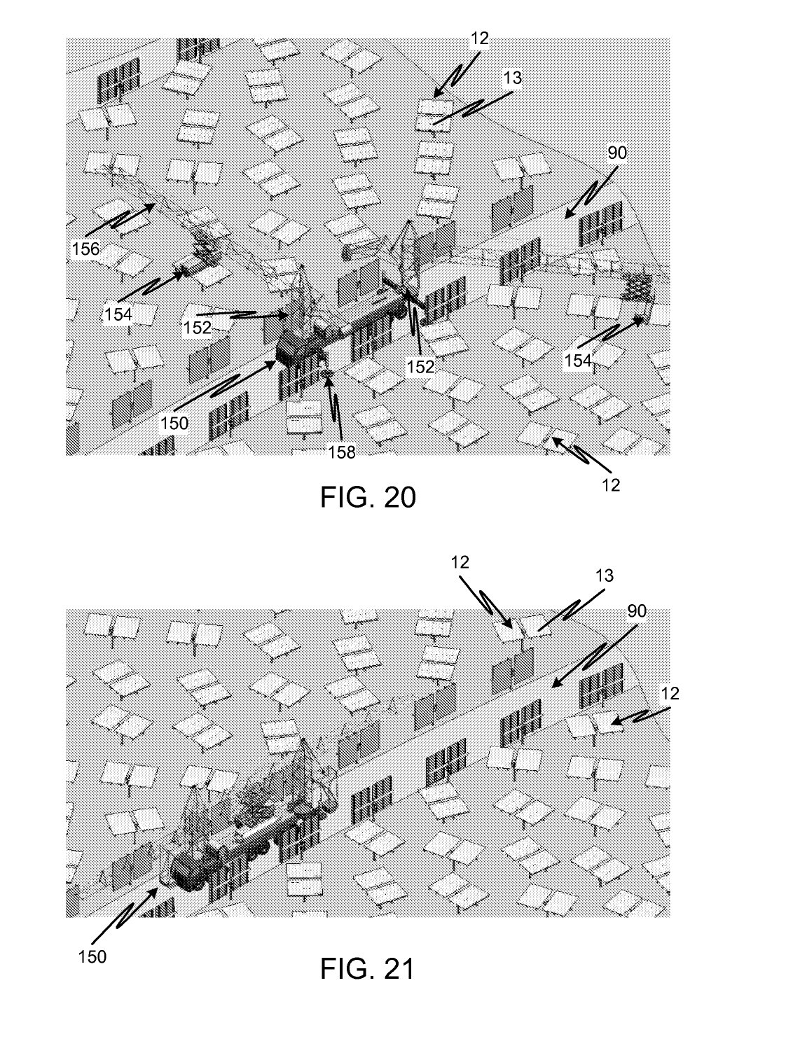

While heliostats 12A, 12B adjacent to the drive path of the vehicle 30 may be directly accessible to the vehicle 30, others of the heliostats 12C-12E away from the path may be isolated or buried with respect to the drive path. The maintenance vehicle 30 can include an arm 34 that can reach over heliostats to access these buried heliostats 12C-12E. The arm 34 can be a robotic arm with a generally vertically extending portion 36A, a generally horizontally portion 36B, and a generally vertically extending portion 36C terminating in a cleaning effecter 38. One or more portions of the arm 34 can be telescopic to enable changes in length that can reach over the heliostats adjacent to the path, e.g., heliostats 12A, 12B, to access buried heliostats, e.g., heliostats 12C-12E. Of course other arrangements for the arm 34 that allow access to the buried heliostats are also possible according to one or more contemplated embodiments. For example, vehicle 30 can be provided with a crane for reaching over heliostats adjacent to a drive path of the vehicle (see FIGS. 15-21).

Examples of a maintenance vehicle 30 include but are not limited to cleaning vehicles, e.g., for facilitating mirror washing, as well as other types of heliostat maintenance vehicles, e.g., for repairing and/or replacing heliostat mirrors. The maintenance vehicle 30 can have a length, width, and height, each of which is at least 0.5 m, at least 1 m, at least 1.5 m, at least 2 m, at least 3 m, or at least 10 m. A ratio between different dimensions of the maintenance vehicle 30 (i.e., ratio between one of length, width, and height, and another of length, width, and height) can be at least 0.25, at least 0.5, at least 0.75, at least 1, at least 1.25, at least 1.5, at least 2, or at least 4. Alternatively or additionally, the ratio between different dimensions of the maintenance vehicle 30 can be at most 0.025, at most 0.5, at most 0.75, at most 1.0, at most 1.25, at most 1.5, at most 2.0, at most 4.0, at most 6.0, at most 8.0, or at most 10.0. The maintenance vehicle may have any type of vehicular shape, including, but not limited to, rectangular prismatic or substantially cylindrical.

Maintenance vehicle 30 may be a relatively large vehicle, such as a flatbed truck or similar vehicle (see FIGS. 15-21). Depending on the size of the drive zone and the size of the maintenance vehicle 30, the maintenance vehicle 30 may not have sufficient room to turn around when it encounters an obstacle along the pathway. Accordingly, the maintenance vehicle may need to reverse direction rather than turning around, which may present issues with traditional large vehicles. In embodiments, the maintenance vehicle may be designed to accommodate easy reverse operation within the drive zone pathway. For example, maintenance vehicle can include a pair of driver cabins—a front cabin and a rear cabin—such that the driver can alternately operate the vehicle at different ends of the vehicle to proceed in a desired direction. In another example, vehicle 30 can be provided with a rotatable cabin, such that the driver can rotate the cabin to face the desired direction. Alternatively or additionally, vehicle 30 can be provided with a relatively tight turning radius, for example, by having four-wheel or multi-wheel steering, to allow the vehicle 30 to turn around with the drive zone.

For a maintenance vehicle designed to clean the surface of the mirror 13 of the heliostats, the cleaning end 38A of the arm 34 can include, for example, a contact cleaning element 37, as shown in FIG. 3B. Contact cleaning element 37 can contact the surface of mirror 13 in order to remove dirt and debris from the surface of the mirror. For example, contact cleaning element 37 may include, but is not limited to, a squeegee, a sponge, or an abrasive material. Alternatively or additionally, a cleaning end 38B of the arm 34 can include, for example, means 33 for streaming a fluid 39 onto the mirror 13 at a set distance D_{35B} from the mirror surface. For example, the means 33 for streaming a fluid can include one or more nozzles that serve to direct pressurized fluid onto the surface of the mirror in order to remove dirt and debris therefrom. For example, the fluid can include, but is not limited to, water or a cleaning fluid.

One or more cameras 38F may be attached to the cleaning effecter 38 and/or one or more cameras 30F may be attached to the vehicle 30 to acquire images of heliostats. The images may be acquired from multiple angles while the vehicle is stationary or moving (using the multiple positions of the vehicle during movement to acquire multiple views). A controller may acquire the images and process to calculate a position and orientation of heliostats to be cleaned. The images may also be processed to determine if heliostats need to be cleaned. The heliostat position and orientation may then be confirmed to lie within predetermined ranges to allow cleaning and/or may be accurately and precisely calculated to control the orientation and positioning of the cleaning effecter 30.

As used herein, a heliostat is considered a buried relative to a particular maintenance vehicle if there is no path for any set of heliostat mirror orientations by which the vehicle may come into direct contact with the heliostat without first coming into contact with or colliding with another heliostat of the solar field. In other words, for a buried heliostat, every path from an initial location of the vehicle (or a location outside of the solar field) to the buried heliostat would require a collision with one or more other heliostats other than the buried heliostat.

The terms buried heliostat or conditionally-accessible heliostat refers to the ability of a particular vehicle to come into contact with the heliostat in view of the geometric properties of the vehicle and the geometric properties and layout of the heliostats of the solar field. When the heliostat is considered buried, contact between the vehicle and the buried heliostat is prevented by other heliostats for all possible heliostat mirror orientations/configuration for the set of all heliostats in the solar field. As will be discussed below, when the heliostat is conditionally accessible, this refers to the prevention of contact under certain conditions (i.e., mirror orientations/configurations) only.

When a vehicle is referred to as coming into contact with a particular heliostat above, this refers to the ability of the vehicle body to directly contact the heliostat at a position along the drive path of the vehicle and not by using an elongated arm 34 to reach the heliostat. Thus, when a vehicle 30 is designated as being able to contact a particular heliostat, it refers to a location on the body of the vehicle and/or on a wheel (or track or tread or tread for tracked/treaded drive vehicle) and/or any location on the vehicle within 4 m or 3 m or 2 m or 1 m of the vehicle's center of mass, which may physically contact or touch the particular heliostat.

Certain heliostats may block direct access to the buried heliostat by the maintenance vehicle 30 because the heliostats have been deployed relatively closely to each other in a relatively dense fashion, the mirrors of the heliostats are sufficiently large enough so as to block passage between adjacent heliostats, and/or the heliostats have been deployed in a particular geometric fashion (e.g., staggered) that may limit maneuverability of the maintenance vehicle among the heliostats (e.g., due to the vehicle's turning radius or the vehicle's length).

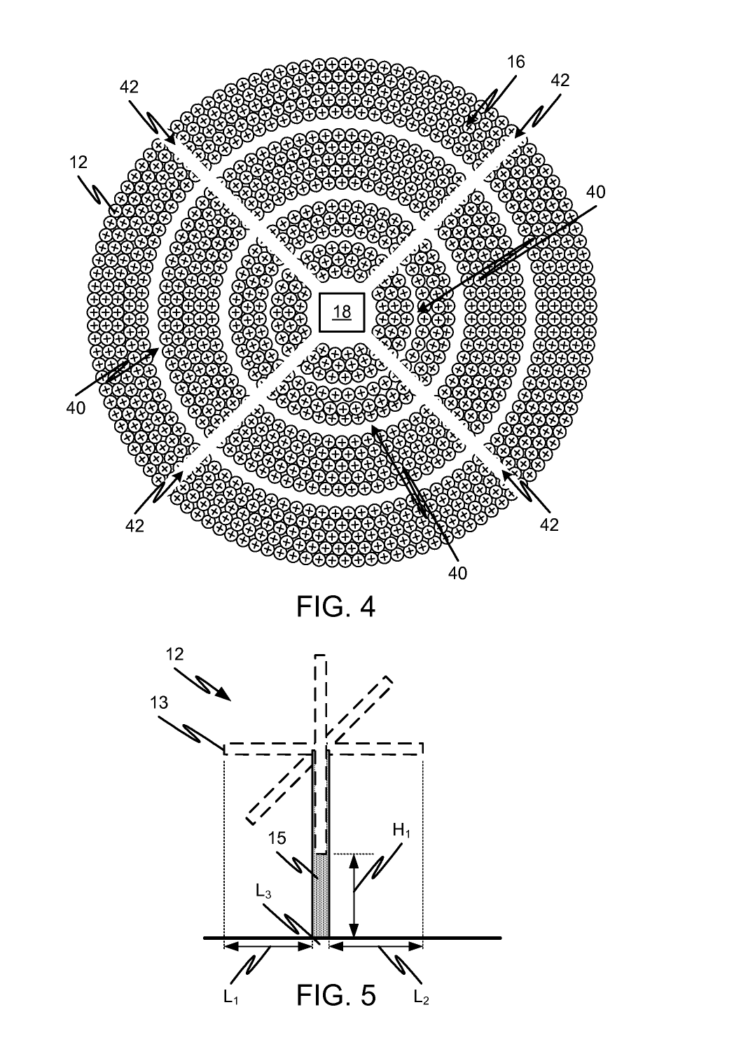

In embodiments, the heliostats 12 in a solar field 16 or in a particular portion of a solar field 16 may be arranged such that the space between adjacent heliostats is insufficient for a maintenance vehicle to pass between. The maintenance vehicle may thus only be able to traverse the solar field 16 or portions thereof via well-defined drive zones or lanes. Referring now to FIG. 4, heliostats 12 are arranged in a relatively dense configuration such that in portions of the field 16, a maintenance vehicle may be unable to pass therethrough. One or more drive zones 42 can be radially directed while one or more drive zones 40 can be a concentric circle centered with the solar tower 18. Although the drive zones 40 and 42 are shown as continuous, the drive zones may be broken into various sections such that zones 40 and/or 42 only exist in certain portions of the field 16 and are thus not continuous through the field.

The drive zone may be defined relative to one or more dimensions of maintenance vehicle 30 in that one may constitute a drive zone for a relatively smaller vehicle may not constitute a drive zone for a relatively larger vehicle. In the solar field 16, at least a majority or most (e.g., at least 80% or 90% or 95% or 99% or more) of the solar field 16 can be considered part of a “no-drive” zone. A maintenance vehicle 30 is unable to access or move through the “no-drive” zone, thereby providing cover and/or sanctuary to animals within the solar field. Thus, the possibility of damage to an animal by movement of in the solar field is greatly reduced and/or minimized.

Moreover, the arrangement of heliostats can allow for movement of animals through the solar field 16, even in the “no-drive” zones where heliostat density may be significant. Referring now to FIG. 5, a heliostat 12 is shown with mirror 13 at different orientations. The heliostat provides a minimum vertical clearance H₁ when the mirror 13 is in a substantially vertical orientation. For example, the vertical clearance H₁ may be in the range of 200 cm, 0.5 m, 1 m or any other value sufficient to provide clearance for an animal to pass below the mirror. Alternatively or additionally, the vertical clearance may be defined based on a lowest point of the mirror 13 during normal operation, i.e., different from the substantially vertical orientation shown in FIG. 5.

The area underneath heliostat 12 is defined by the mirror 13 being in a substantially horizontal orientation, thereby defining a first horizontal clearance L₁ and a second horizontal clearance L₂, each having a width (not shown), in which an animal may roam free unobstructed by the heliostat 12 and/or a maintenance vehicle 30. A support structure 15, such as a pylon, holds the mirror 13 at a specific orientation. The support structure 15 provides an obstruction at ground level having a length L₃ and a width (not shown) which an animal would not have access too. However, the length L₃ is substantially smaller than the lengths L₁ and L₂, thereby allowing at least a majority or most of the region underneath a heliostat 12 to be accessible to an animal, such as the desert tortoise. It is noted that desert animals, including but not limited to desert tortoises, tend to be shorter than the vertical clearance H₁ provided by the heliostats.

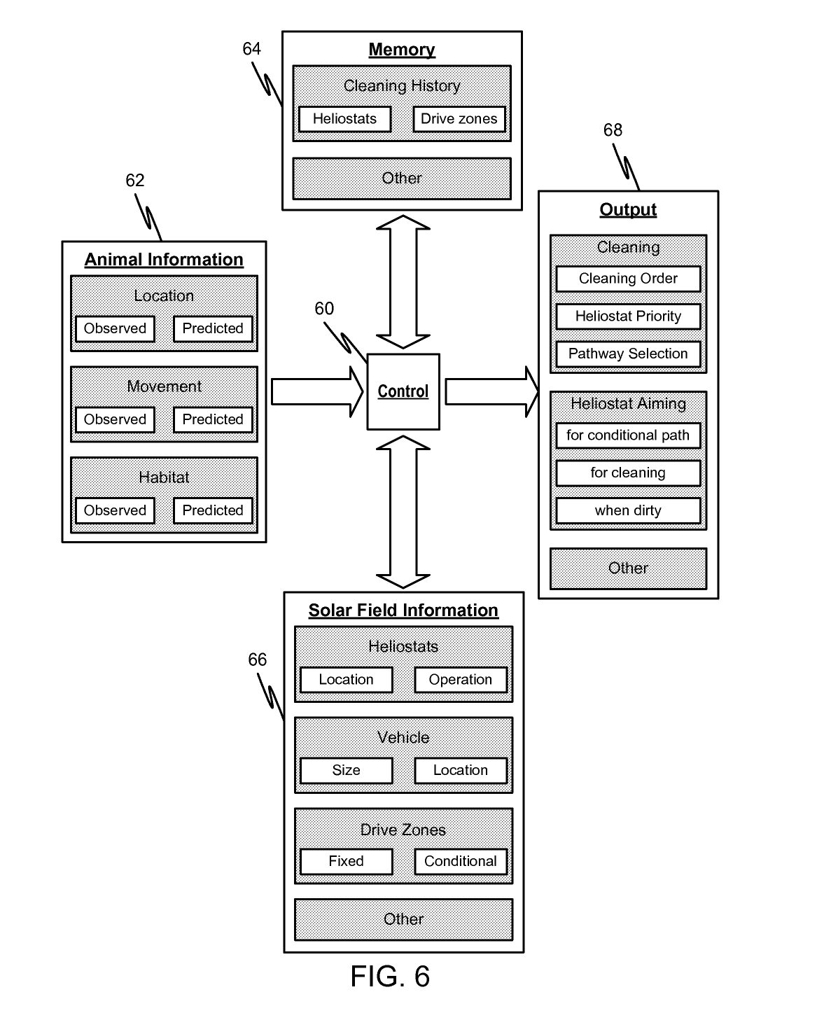

Control of maintenance operations and/or actual operation of the solar power system, including the heliostats in the solar field and/or electricity generation, may be based on a number of factors including, but not limited to, a cleaning schedule, animal information, and optimizing energy production. For example, referring to FIG. 6, control 60 of maintenance and/or operation of solar field can take into account certain information 62 regarding an animal, information 64 stored, for example, in a memory (either together with the control system 60 or separate from the control system 60), and information 66 regarding the solar field 16 itself. The control system 60 can thus articulate an output 68 for maintaining (e.g., cleaning, repairing, or replacing heliostats) and/or controlling (e.g., heliostat aiming or boiler operation) the solar field 16.

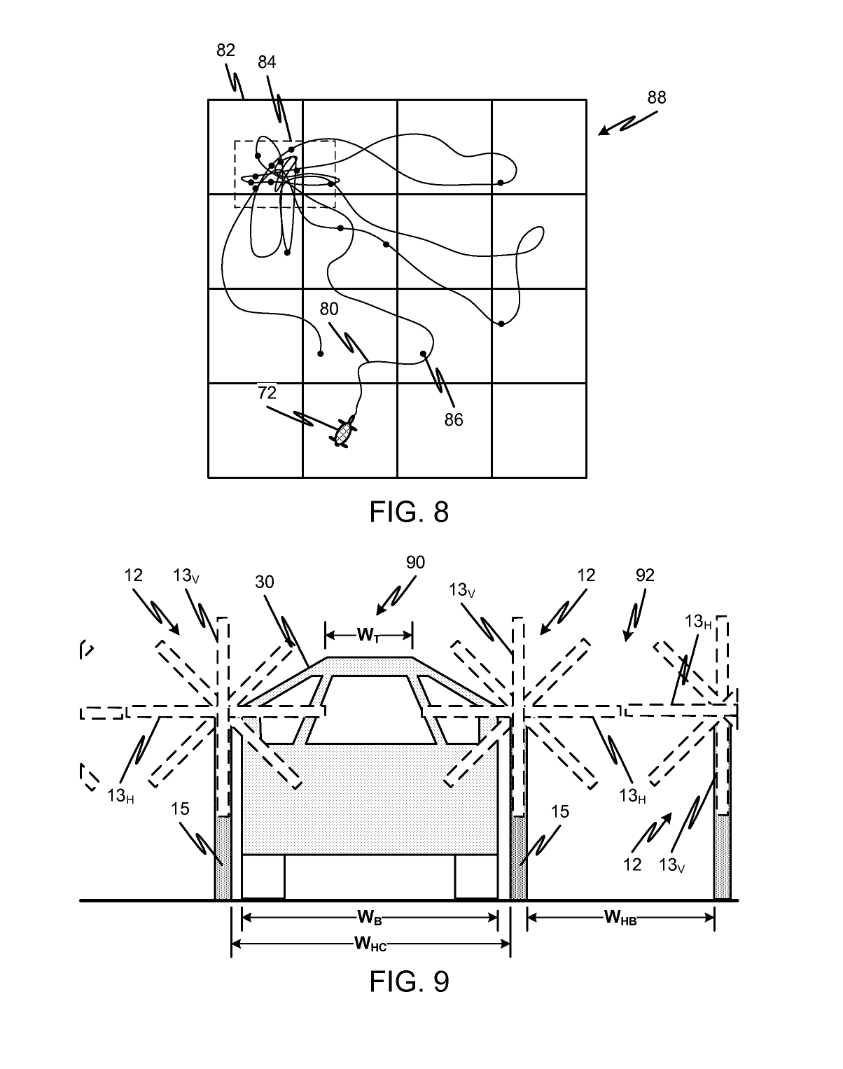

Regarding animal information 62, the control system 60 may take into account one or more different factors, including, but not limited to, observed animal location, predicted animal location, observed animal movement, predicted animal movement, observed animal habitat location, and/or predicted animal habitat location. For example, an animal in the solar field 16 may be tagged with a radio transmitter or other tagging mechanisms such that the location of the transmitter or tag sufficiently describes the location of the animal. In another example, radar, sonar, ultrasound, infrared imagers, and/or visual light imagers may be used to monitor the location and/or movement of the animal. In another example, data regarding an animal location or movement may be used to predict location of the animal at a later period of time, to predict movement of the animal at a later period of time, or to predict a location and shape of an occupancy zone of an animal or an animal's habitat (see the discussion associated with FIG. 8 below). The prediction may be performed by control system 60 or as part of the animal information 62 input to control system 60.

One or more image-processing techniques or combination of image-processing techniques can be used to determine and/or predict animal location, movement, and/or habitat. For example, it is possible to acquire either a static image and/or a series of images (e.g., video) using one or more cameras at one or more locations in the solar field 16 and/or on any maintenance vehicle 30 and/or a imaging vehicle (i.e., smaller and/or more mobile with a maintenance vehicle) and/or at any other location capable of imaging a portion of the solar field 16. One non-limiting example of such an image-processing technique relates to the motion-detection routines that are commonly employed by digital cameras. In yet another example, a database of images of one or more ‘target species’ is maintained, and it is possible to attempt to match a candidate image from the solar field, which may or may not include an animal, with one or more image of animals in the database of images of the target species, e.g., endangered or threatened species. Such a database may be included, for example, in memory 64.

Alternatively, acoustic systems such as acoustic imaging, or passive audio detection and pattern recognition may be used to locate and identify animal movement and location information and events. For example, locations can be determined by acquiring audio from multiply positioned microphones and triangulating to determine position and velocity. Further prediction information may be generated based on models of animal behavior and current position and trajectory as well as historic position and trajectory information. In all embodiments where optical methods and apparatus are described, it will be understood that these may be replaced by such acoustical methods and apparatus where practical to provide the identified ultimate functions. In addition satellite or aerial imagery (visual or non-visual spectrum including radar, infrared, ultraviolet imaging data) may be used to predict movement of animals or other vulnerable areas of concern and provided as input as described above to systems for route planning.

In embodiments, an image and/or any other physical reading of a region of the solar field 16 may be classified as either (i) indicative of a presence of the non-domestic animal and/or (ii) not indicative of the presence of the non-domestic animal. This classification may depend on the physical readings from the field and/or one or more thresholds for deciding when the data indicates the presence of an animal in the solar field. The values of these thresholds may depend upon the costs associated with a “false positive” (i.e., determining that there is an animal present when in fact no animal is present) and with a “false negative” (i.e., determining that there is no animal present when in fact there is an animal present). These thresholds may be determined on a per-species basis, where more consideration, such as lower threshold values which may lead to more false positives, is given to endangered or threatened species. Information provided to control system 60 regarding animal information 62 may include input from a human operator or expert, such as a naturalist. For example, images of portions of the solar field may be provided to a human operator for further classification, i.e., determining if an animal is actually an endangered species necessitating a lower threshold value.

The location of an animal habitat may be detected in a number of ways. In one example, naturalists may manually walk within solar field 16 and identify the locations of the animal habitat 74, including habitats that may be located underground and subject to disruption by a maintenance vehicle. In another example, images may be manually and/or automatically acquired and manually and/or automatically analyzed. In yet another example, the movements of an animal are tracked over time, and a location of the animal's domicile/habitat is determined based on the results of the tracking (see, for example, the discussion associated with FIG. 8).

In addition to a database of animal images, memory can include images of various portions of the solar field 16 or of different scenarios for use by control system 60 in determining maintenance or control outputs 68. Additionally or alternatively, the cleaning history of heliostats and/or drive zones utilized can also be stored in the memory. As will be described in further detail below, certain heliostats may be left uncleaned or certain drive zones may be impassable due to the presence of an animal or its habitat. Memory 64 may store this information for access by control system 60. For example, control system 60 may use this information in prioritizing heliostats for cleaning, re-aiming or compensating for dirty heliostats, and/or selecting drive zones or alternative drive zones for cleaning heliostats.

Additionally or alternatively, the control system 60 can receive information 66 regarding the solar field in order to determine a maintenance and/or operating output 68. For example, the solar field information 66 can include, but is not limited to, the location of heliostats 12 within the solar field 16, a desired operation of heliostats 12 (e.g., sun tracking information), maintenance vehicle size, maintenance vehicle location (e.g., position along a path), location of permanent drive zones for a particular maintenance vehicle (e.g., drive zones 40 or 42 in FIG. 4), and location of conditional drive zones for a particular maintenance vehicle (e.g., drive zones only conditionally available by reorienting heliostats, discussed in further detail below). Memory module 64 and solar field information module 66 may be combined in a single module (not shown), combined together as part of control system 60, separately integrated as part of control system 60, or as a separate combined memory-field information module.

The control system 60 may use the animal information 62, memory module 64, and/or solar field information module 66 to determine maintenance and/or operating criteria for the solar field 16. Output 68 from control 60 may be directed to one or more components of the solar field 16, such as the individual heliostats 12, maintenance vehicle 30, and/or any other component or system of the solar power system. For example, output 68 may include instructions or control algorithms for cleaning heliostats in the solar field. The control system 60 may determine a cleaning order of heliostats or select a particular pathway along designated maintenance vehicle drive zones, for example, to avoid an animal or habitat in a maintenance vehicle drive zone. Heliostat cleaning history may be used to determine priority for certain heliostats that haven't been cleaned in a predetermined period of time.

Additionally or alternatively, operation of the heliostats may be controlled by the control system 60 (or another control system based on the output from control system 60) to account for maintenance or lack thereof. For example, dirty heliostats may reflect insolation at the receiver 20 with less efficiency. Other heliostats may be re-aimed to compensate for the reduced reflected flux caused by the dirty heliostat. Optimization may be performed by the control system 60 to re-aim one or more of the heliostats, whether clean or dirty, so as to maintain a temperature uniformity of the receiver 20. Dirty heliostats may be re-directed at less temperature critical regions of the receiver or a different receiver, such as an evaporator section. The control system 60 can also control certain heliostats 12 to compensate for other heliostats currently undergoing maintenance. For example, when a portion of the solar field is being cleaned, heliostats in a second portion of the solar field may be re-aimed at the receiver 20 to compensate for the loss of flux due the heliostats being cleaned.

Control system 60 can also control the heliostats to reposition for cleaning For example, the mirrors 13 of the heliostats 12 may be re-oriented to a substantially horizontal position to allow for cleaning by the maintenance vehicle 30. Re-orientation of the mirrors 13 of the individual heliostats 12 may also occur to allow for a conditional drive zone for use by a particular maintenance vehicle. For example, the mirrors 13 of heliostats 12 substantially adjacent to a conditional drive zone may be re-oriented to a substantially vertical position to allow the maintenance vehicle 30 to pass by. Additionally or alternatively, the heliostats may be controlled so as to avoid any potential disruption to an animal located in the solar field. For example, if an animal in the solar field has a height sufficient to contact the heliostat mirror 13 for certain mirror orientations, the control system 60 may control the heliostats around the animal to avoid those mirror orientations.

Control system 60 may also control the operation of the maintenance vehicle 30 within the field. For example, the speed of maintenance vehicle 30 within the field may be limited in accordance with a threshold or confidence level that an animal is present, even if the animal is determined not to be currently in the maintenance vehicle drive zone. If it is estimated that there is only a small likelihood of a presence of an animal, the maintenance vehicle 30 may be allowed to operate in a particular region of the solar field subject to one or more constraints. Such constraints can include but are not limited to speed constraints, the use of water or cleaning solution to clean the heliostats, maximum flow rates of water or cleaning solution in cleaning the heliostats, noise constraints, and/or other operating parameters of the maintenance vehicle.

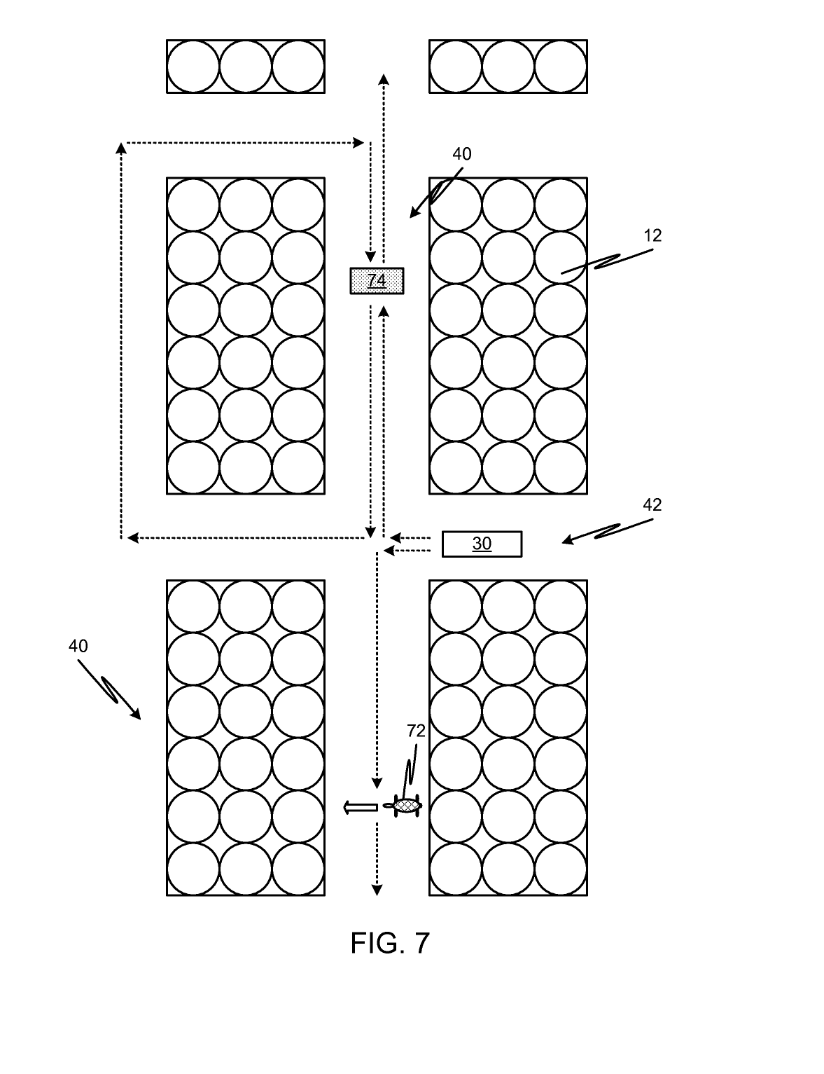

Referring now to FIG. 7, a maintenance vehicle 30 operates in solar field 16 to effect maintenance of heliostats 12, for example, by cleaning the surface of mirrors 12 of the heliostats 12. Maintenance vehicle 30 can access the solar field 16 through radially directed permanent drive zones 42 and perpendicular permanent drive zones 40. Drive zones 40 and 42 thus separate various sections of the heliostats 12 from each other and allow access to the heliostats by the maintenance vehicle 30. Operation of the maintenance vehicle may depend on the location of an animal, such as tortoise 72, or an animal habitat, such as burrow 74, within a particular drive zone 40. As the maintenance vehicle 30 proceeds along drive zone 40, if it encounters a habitat 74, it may retrace its path and attempt to circumvent the habitat 74. For example, the maintenance vehicle 30 may approach the habitat from the top so as to be able to access the heliostats it was unable to reach by approaching from the bottom. If the maintenance vehicle 30 encounters a mobile animal 72 when proceeding along drive zone 40, a cleaning speed can be reduced to give the animal sufficient time to move out of the drive zone 40 before the maintenance vehicle 30 reaches that location.

Alternatively or additionally, the maintenance vehicle 30 can wait in the drive zone 40 until the animal leaves the drive zone before proceeding along the designed pathway. Whether to wait or pursue an alternative pathway in view of the blockage by an animal may be determined based on a time the animal is estimated to be in the drive zone. This estimation may be made according to species identification (e.g., tortoises would be estimated to spend more time in the drive zone than faster moving animals), time of the year, and/or historical recorded speed in the solar field for the particular animals. In the event that the estimated amount of time is less than a predetermined threshold, then the maintenance vehicle may pause along the pathway until the animal no longer blocks the pathway. Otherwise, the maintenance vehicle may proceed along an alternative pathway to avoid the blockage.

In another example, control system 60 may be controlled to avoid cleaning certain heliostats responsively to a calculated predicted probability the animal will be in the pathway for an extended period of time or if operation of the solar tower system requires the flux from the heliostats. Cleaning of the heliostats may thus be delayed for a period of time, such as hours, days, weeks, or other period of time. Identification of dirty heliostats and time between cleanings may be stored in, for example, memory 64 and cleaning scheduled (for example, prioritized) responsively to this stored data. Because the mirror surface of an uncleaned heliostat may be dirty, the heliostat may be less effective at directing insolation at the tower 18 thereby reducing the system efficiency; however, the coexistence of threatened or endangered animal species within the solar field may outweigh this reduction in system efficiency.

Referring now to FIG. 8, a grid system 88 can be superimposed onto a portion of the solar field 16 in which an animal 72 is determined to be located. The location of the animal or a population of animals can be monitored over time (continuously or discretely), for example, using a radio tag attached to a representative animal 72 or multiple animals. The animal 72 may proceed along pathway 80 within the solar field. At each equal installment of time a point 86 along the pathway 80 may be noted. A conglomeration of points 86 may suggest that a particular location is a habitat 74 for animal 72. For example, a location of points 86 in grid 82 suggests that the animal 72 spends most of its time in this grid 82. The grid 82 may thus be classified as having a habitat 74 therein, and a maintenance vehicle 30 may be prohibited from traveling through the grid 82. Additionally or alternatively, a habitat location may be designated by an arbitrary shape 84 irrespective of the grid and containing a significant number of time points 86.

Alternatively or additionally, daily or annual movement patterns of animal 72 may be analyzed to predict a location/movement of an animal 72 or to determine a location of the habitat 74. For example, the movement of an animal (or a set of animals) can be monitored over a predetermined period of time, such as several days, a week, a month, or even several months. Based on this data, it can be predicted where an animal or group of animals are generally located as a function of time of day or time of year. The maintenance vehicle may thus be prohibited from entering the predicted locations at those times. For example, a tortoise may spend more time in a first region early in the day (or during a particular time of year) and more time in a second region closer to night (or during another time of year). The maintenance vehicle may thus be prohibited from operating, or at least allowed to operate with certain constraints, in the first region early in the day and in the second region closer to night.

In embodiments, conditionally accessible pathways or conditional drive zones 90 may exist within the field 16 of heliostats 12 for a particular maintenance vehicle 30. Conditional drive zones 90, as used herein, refers to a particular pathway through the solar field 16 that is only accessible to a particular maintenance vehicle 30 when the mirrors 13 of heliostats 12 adjacent to the drive zone are in a particular orientation. For example, referring to FIG. 9, a conditional drive zone 90 exists between a pair of heliostats 12 in the solar field 16. When the mirrors of the heliostats 12 are in a substantially horizontal orientation 13_{H}, the width W_{B} of the maintenance vehicle is greater than the width between ends of the mirrors, thereby preventing the maintenance vehicle from passing along pathway 90. When the mirrors of the heliostats 12 are in a substantially vertical orientation 13_{V}, the width W_{B} of the maintenance vehicle is less than the distance W_{HC} between the heliostat support structures 15, thereby allowing the maintenance vehicle to pass along pathway 90.

A heliostat, as used herein, can include either a single mirror (see FIG. 36) or a mirror assembly of one or more mirrors (see FIG. 37) that can rotate in tandem in rigid body rotation. The mirror assembly 13 of a particular heliostat 12 may, at a given time, have an orientation defined by, for example, an ordered pair of coordinates, hₒₙₑₙₜₐₜᵢₒₙ_{_{—}}ᵢ=(θᵢ, φᵢ), where θᵢ represents the elevation angle and φᵢ represents the azimuth angle. The heliostat 12 may have one or two rotational degrees of freedom, and rotations may be expressed consistent with the elevation/azimuth description or in any other manner.

In order for the maintenance vehicle 30 to pass along conditional pathway 90, it is not necessary that the mirror be arranged in a substantially vertical position 13_{V}. Rather, the heliostats 12 and maintenance vehicle 30 may be designed and arranged to allow the mirrors 13 to be at an angle different from vertical. For example, the width W_{T} at the top of the maintenance vehicle 30 and the width W_{B} at the bottom of the maintenance vehicle 30 may be designed to allow the maintenance vehicle 30 to pass along pathway 90 even when the mirrors 13 are oriented different from vertical 13_{V}, as shown in FIG. 9.

In contrast, heliostats 12 in other parts of the field 16 may be spaced closely together such that even when the mirrors 13 are arranged in a substantially vertical orientation 13_{V}, the distance W_{HB} between adjacent heliostat support structures 15 is less than the width W_{B} of the maintenance vehicle. Thus, there may be insufficient distance between the heliostats to allow the maintenance vehicle 30 to pass through regardless of mirror orientation. It is appreciated that this due to the combination of the size of the maintenance vehicle 30, size of the heliostats 12, structure of the heliostats 12, arrangement of the heliostats 12, and/or separation distance between heliostats 12. Such heliostats may be referred to as buried heliostats since they are not directly accessible by the maintenance vehicle 30.

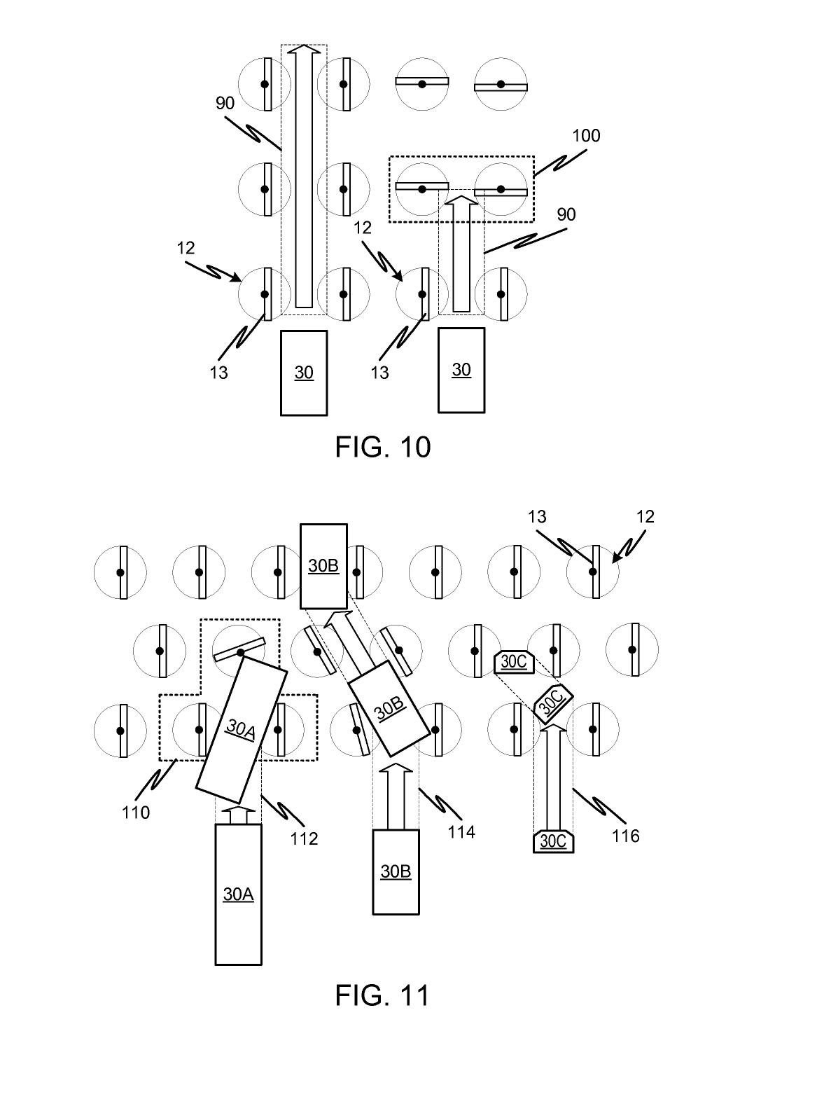

FIGS. 10-11 relate to the condition where a maintenance vehicle 30 may or may not pass in a region populated by heliostats 12. In these figures, a center (or centroid or support structure) of each heliostat is drawn as a dot, the mirror 13 of the heliostat is represented as a rectangle which may rotate around the dot, and a range of motion of the mirror 13 in plan view is represented as a circle around the dot. FIGS. 10-11 have been simplified and assume that the region of each heliostat is contiguous and shaped as a circle. It will be appreciated that in practice this simplified schematic should not be understood as limiting. Moreover, FIGS. 10-11 relate to a projection from 3-D space into 2-D space, i.e., an aerial view. It will be appreciated that the blocking features of any heliostat may apply in any manner relevant for a 3-D heliostat of any shape. The mirror assembly of the heliostats may thus have any shape, and the heliostat itself may have any configuration.

As shown in the left side of FIG. 10, vehicle 30 can traverse the solar field along conditional pathway 90 because the mirrors 13 of heliostats 12 adjacent to the pathway 90 are at a greater distance than the width of the vehicle 30 due to orientation of the mirrors 13. However, when the mirrors 13 are oriented differently as for the group 100 of heliostats 12, the pathway is blocked and prevents vehicle 30 from passing group 100, as shown in the right side of FIG. 10. It is noted that although the mirrors 13 in group 100, as illustrated, suggest a vertical orientation, the illustration can also represent mirrors 13 in a substantially horizontal position that obstructs the pathway.

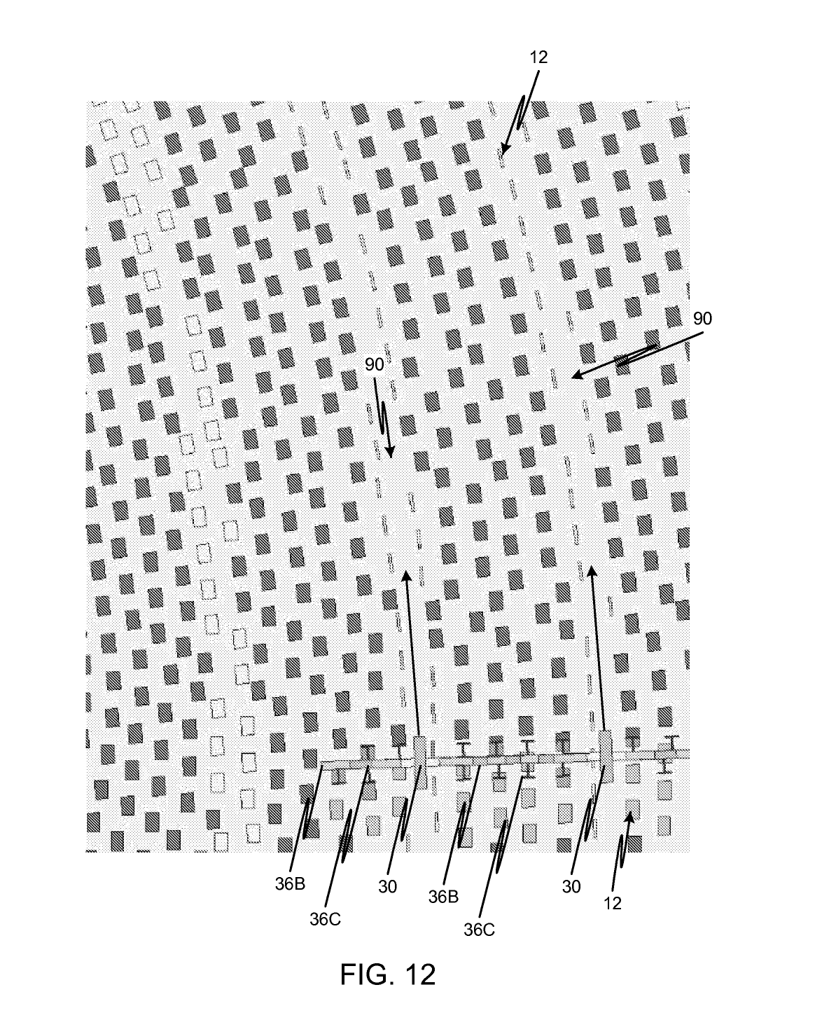

Referring now to FIG. 12, arrangement of the heliostats 12 in conjunction with the size of a maintenance vehicle 30A may be such that vehicle 30A is unconditionally blocked from moving through the section 110 of heliostats 12. Even if the vehicle 30A can pass through one pair of heliostats in the bottom row (i.e., there is width clearance), the vehicle is impeded from moving further through the field because of the obstruction caused by heliostats in the second row. In particular, the length and width of the vehicle 30A in conjunction with the arrangement and spacing between heliostats prevents the vehicle 30A from turning along pathway to avoid impact with the heliostat in the second row.

In contrast, maintenance vehicle 30B is shorter in length than maintenance vehicle 30B, but has the same width. Although maintenance vehicle 30B was prevented from moving through the field of heliostats 12 by section 110, maintenance vehicle 30B is allowed to move along a conditional pathway 112 due to its reduced size. It is also noted that heliostats 12 adjacent to the conditional pathway 112 can be controlled and re-oriented to accommodate the turning and movement of the maintenance vehicle 30B as it proceeds along pathway 112.

Finally, maintenance vehicle 30C is shorter in length than either maintenance vehicle 30C, but has the same maximum width and a rounded front shape. Although maintenance vehicle 30B may necessitate re-orientation of the heliostats adjacent to its pathway 112 as it passes through the field, maintenance vehicle 30C is sufficiently small that it can turn and move along pathway 114 with the mirrors 13 of the heliostats 12 maintained in a consistent position. Accordingly, the concept of a buried heliostat and/or buried location (versus conditionally accessible heliostat or conditionally accessible location) is based on the vehicle as well as the arrangement of heliostats, in particular vehicle dimensions or turning radius.

Maintenance vehicle 30 may proceed along one or more conditional drive zones 90 and/or one or more permanent drive zones 40, 42 in order to clean and/or maintain the mirror 13 of one or more heliostats 12 in the field, including heliostats adjacent to a drive zone and/or isolated from the drive zone (i.e., buried). Such a cleaning can be a contact cleaning, as illustrated in and discussed with respect to FIG. 3B, and/or a non-contact cleaning, as illustrated in and discussed with respect to FIG. 3C. The contact cleaning can transpire at a time when there is mechanical contact or a mechanical connection between maintenance vehicle 30 and the heliostat 12 via an object (e.g., end 38) or including various attached components. Additionally or alternatively, the maintenance vehicle 30 may provide a contact service operation to the heliostat, such as repairing or replacing a portion of the heliostat.

In embodiments, islands of buried heliostats in the solar field 16 may be bordered by permanent drive zones and/or conditionally accessible drive zones 90. For example, as shown in FIG. 12, a pair of maintenance vehicles 30 may proceed along circumferentially-directed conditional pathways 90 in a solar field 16. Although all of the mirrors 13 along pathway 90 are illustrated as being in a substantially vertical position to allow the maintenance vehicle 30 to pass, it is also contemplated that the mirrors 13 operate according to a “just-in-time” protocol, thus only orienting into position to allow maintenance vehicle 30 to pass when the maintenance vehicle is close to the mirror 13. Thus, most of the pathway 90 may be obscured by mirrors 13 which to continue to aim at the receiver in the tower, until re-orientation is needed to allow the maintenance vehicle 30 to pass.

The same “just-in-time” concept can also be applied to mirrors 13 to be cleaned. In other words, buried heliostats 12 would continue to focus insolation onto the receiver until cleaning of the particular heliostat 12 is imminent. Additional control of the heliostats may take into account obstruction of the heliostat line of sight during cleaning. For example, cleaning of one or more heliostats using arm 36B may block reflected insolation from one or more heliostats, which may have already been cleaned or are waiting to be cleaning, from reaching the designated aiming point on the target in tower 18. Accordingly, the heliostats may be temporarily re-aimed to avoid obstruction caused by the arm 36B.

It is also noted that the location of pathway 90 need not be a set pathway or a regular pathway (i.e., a concentric circle pathway as illustrated in FIG. 12). Rather, pathway 90 may be an ad hoc pathway and/or an irregular pathway. The maintenance vehicle 30 may be able to pick and choose its way through the solar field 16 with appropriate control of heliostats to allow access therebetween. Thus, at any instant of time, it may appear that the maintenance vehicle 30 is itself buried within the solar field 16 without any particular exit pathway evident, but appropriate control of heliostats 12 can allow a pathway to open as the maintenance vehicle 30 moves. Such ad hoc pathways can also be used to avoid animals and/or their habitats within the solar field. For example, a maintenance vehicle can be controlled to maneuver around animals and/or animal habitats by selectively choosing an ad hoc pathway through the heliostats. Heliostats along this ad hoc pathway can be controlled to allow the maintenance vehicle to pass.

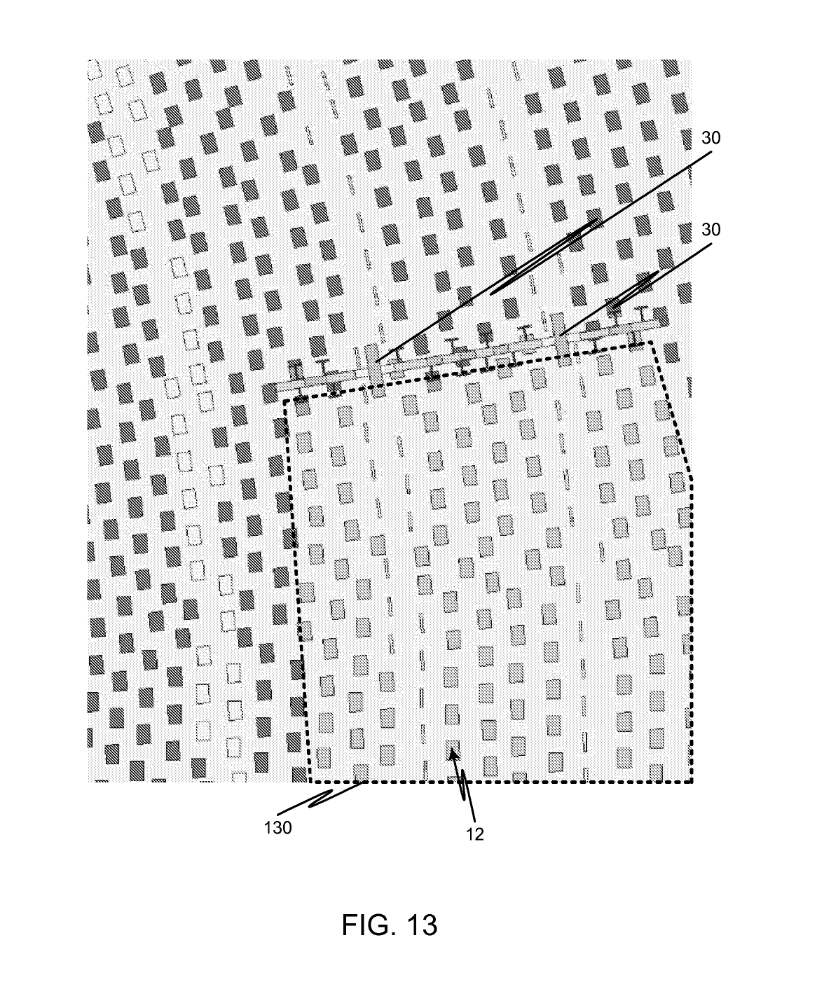

Heliostats 12 remote from the pathway 90 are not directly accessible by the vehicles 30; instead, intervening heliostats prevent direct access. To reach these buried heliostats 12, one or more arms 36B attached to the maintenance vehicles 30 may reach over the intervening heliostats 12. The arms 36B can include one or more cleaning ends 36C to clean multiple heliostats simultaneously. The cleaning ends 36C can include a brush or a short-range squirt or spray device, which may operate over a distance between the device and the mirror surface of less than 2 m. The maintenance vehicles 30 can continue along the circumferential conditional pathways 90, leaving behind a section 130 of substantially clean heliostats in their wake, as shown in FIG. 13.

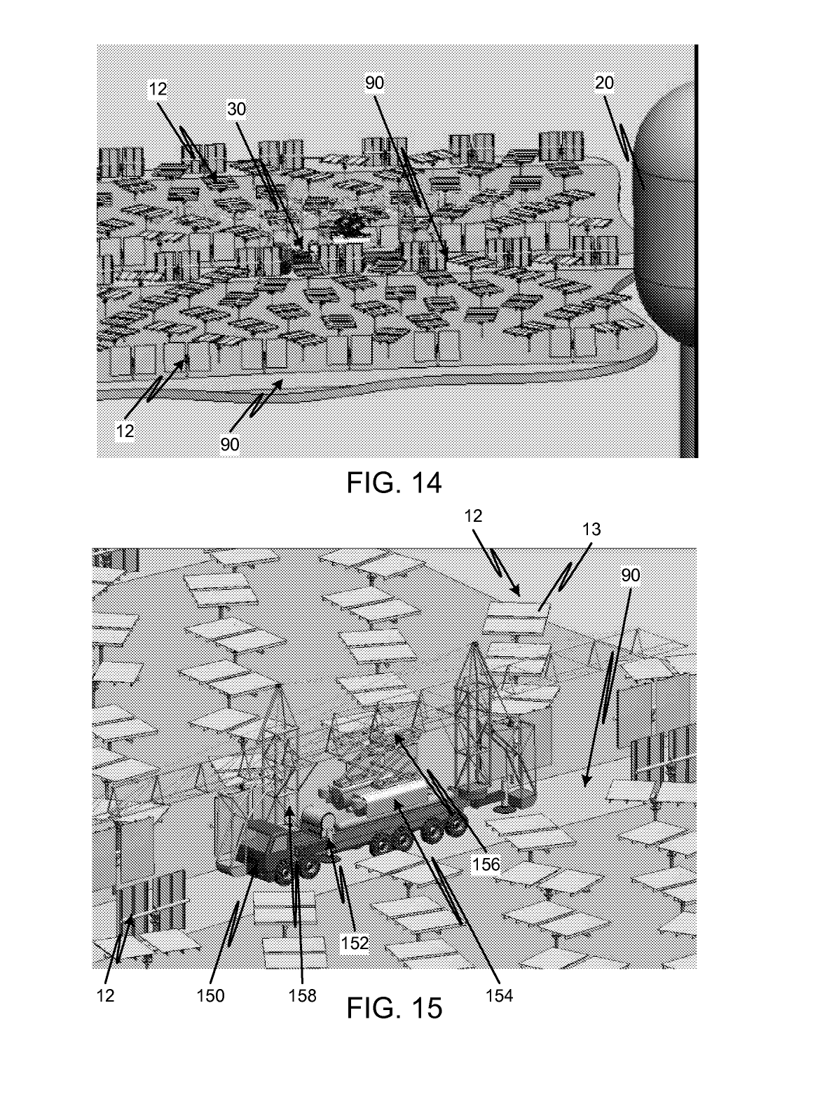

FIG. 14 illustrates a field of heliostats 12 as viewed from a location near the top of a tower 18, i.e., near receiver 20. FIGS. 15-21 illustrate a series of frames showing the cleaning of heliostats by one embodiment of a maintenance vehicle 150. In particular, the maintenance vehicle 150 can proceed along a conditional pathway 90 in order to access heliostats 12 within the field 16. Heliostats adjacent to the conditional pathway are oriented in a substantially vertical direction, thereby allowing the vehicle 150 to move along the pathway 90. In contrast, heliostats remote from the conditional pathway 90 are oriented in a substantially horizontal direction to allow for cleaning.

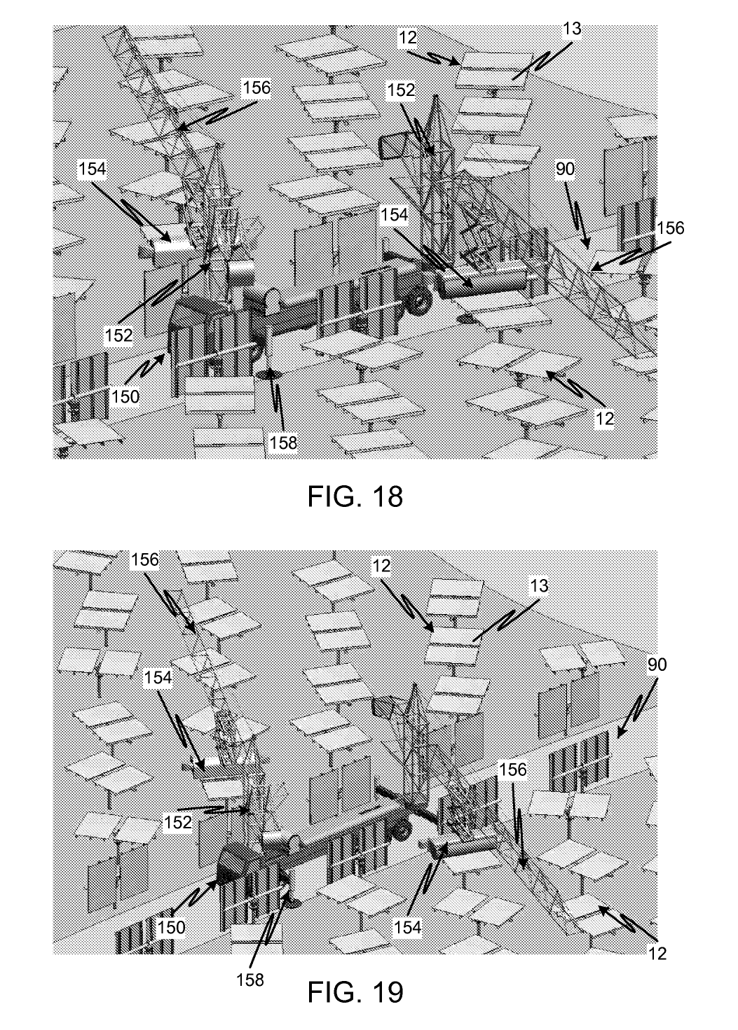

The maintenance vehicle 150 may include one or more cranes 152 with a boom 156 that can reach out into the field of heliostats away from the conditional pathway 90. A roller-type cleaning device 154 or any other type of cleaning device may be supported by the boom 156 for providing direct contact with the mirror 13 (see FIGS. 18-19). One or more ground supports 158 on the maintenance vehicle 150 can be temporarily engaged to support the maintenance vehicle 150 during the cleaning operation.

In embodiments, the heliostat density and/or arrangement may not be consistent throughout the solar field 16. Rather, heliostat density may vary depending upon location in the solar field 16. For example, the heliostat density, as measured by heliostats per unit angle, may increase toward the outer edge (i.e., away from the tower 18) as compared to the inner portion of the field 16. The heliostat density may increase by a factor of 1.2, 1.5, 2, 3, or 5 between an inner portion of the field 16 and an outer portion of the field 16.

The heliostat density for a region/section of the solar field is the number of distinct heliostats within the region (or sub-region) of land divided by the area of the region/section of land. The region/section of land may be any shape including but not limited to rectangular, wedge-shaped, annular-shaped, triangular, or any other shape. It is appreciated that in a single solar field some regions may have some sub-regions with a greater heliostat density and other sub-regions with a lesser heliostat density. For example, it may be advantageous to deploy heliostats at a greater heliostat density closer to a given tower, and with a lesser heliostat density farther from the tower(s).

Although not an explicit requirement, any of the embodiments described herein may refer to “single-tower” systems where heliostats 12 associated with a tower 18 and/or configured to re-direct insolation to a tower 18 or portion thereof substantially only re-directs insolation to a single tower 18, even if more than one tower 18 is located at a given solar power system site. This feature may apply to any heliostat and/or set of heliostats (for example, north-field heliostats and/or south field heliostats and/or west field heliostats and/or east-field heliostats). In some embodiments, no insolation is re-directed to other towers 18 from the heliostats associated with the single tower 18.

Over a period of time (for example, at least one week, at least 1 month, at least 3 months, at least 6 months, at least 9 months, at least 1 year, at least 2 years, or at least 3 years), a heliostat 12 or group of heliostats that re-directs insolation to a solar tower 18 may, in fact, be configured such that less than 30%, less than 20%, less than 10%, less than 5%, less than 3%, or less than 1% of all of the insolation re-directed by the heliostat 12, by each heliostat 12 of the group, or by the group as a whole is directed to other towers 18 other than the designated solar tower 18.

The term geometrically efficient refers to a ratio between a size of a lone heliostat seen from a tower and/or the amount of insolation reflected by a lone heliostat at a particular time of day/year and the physical size of the heliostat. Thus, when looking down from the top of the tower upon a solar field, southern heliostats may appear smaller than equivalently-sized and equivalently-located northern heliostats due to cosine effects. The term lone heliostat efficiency parameter of a heliostat deployed in a location refers to the size of the heliostat as it would appear viewed from the target at or near the top of the tower for the case where there are no other heliostats in the field. The term lone heliostat efficiency parameter may be used interchangeably with geometrical efficiency of a heliostat.

A distance between the tower and the heliostat relates to a distance between a centroid of the tower at ground level and a location of the heliostat. A location of a heliostat is defined as the ground-level downward projection of the heliostat centroid. A distance between two heliostats is the Cartesian distance between their respective locations. The size of a heliostat or the area of heliostat is the area of all mirrors of its mirror array. Some heliostats can include a single mirror 13, as shown in, for example, FIG. 36. For these single-mirror heliostats, the size of the heliostat is the area of the single mirror. Multiple mirror heliostats can have one or more heliostat motors to rotate the mirrors in tandem to track the sun. For example, the multiple mirror heliostat can include a pair of mirrors 13A, 13B, as shown in FIG. 37. For these multiple mirror heliostats, the size is the sum of all mirror areas for all mirrors of the heliostat.

TABLE 1
Examples of Heliostat Dimensions

| | | | | Height |
|---|---|---|---|---|
| | | | | (H) from |
| | | Number | Size of | horizontal |
| Type of | FIG. | of | each mirror | axis to |
| heliostat | no. | mirrors | (mm) | ground (mm) |
| Single Mirror | FIG. 36 | 1 | 3210 × 2250 × 4 | 1300 |
| Double Mirror | FIG. 37 | 2 | 3210 × 2250 × 4 | 1900 |

The total mirror size or the aggregate mirror size for heliostats deployed in a region/section of land is the total/aggregate size of all of the heliostats (i.e. the aggregate area of all mirrors where each heliostat bears a mirror assembly having one or more mirrors) within the region/section/sub-section of land. The various heliostats in this land may include any number of mirrors in the mirror assemblies.

It is also possible to compute the total mirror density or the aggregate mirror density for heliostats deployed in the region/section of land as the ratio between the total mirror size or the aggregate mirror size and the area of the land region or sub-region. Measurement units for heliostat density are number of heliostats per unit of area, e.g., heliostats per m². On the other hand, mirror density is typically dimensionless, e.g., as mirror area per unit of land area.

Cardinal directions refer to due north, due east, due south and due west (in any order). A time that is referred to as late afternoon may begin any time after 1 PM, after 2 PM, or after 3 PM local solar time, while it may end at sunset, 15 minutes before sunset, 30 minutes before sunset, 60 minutes before sunset, 90 minutes before sunset, or even 2 hours before sunset.

A location at or near a top of a solar tower may be at the top within a tolerance that is at most 25% of a height of the tower, at most 20% of a height of the tower, at most 15% of a height of the tower, at most 10% of a height of the tower, at most 15% of a height of the tower, or at most 5% or a height of the tower.

A non-dumping period of time relative to one or more target(s) 20 at or near the top of the tower is a period of time whereby the flux incident upon the target 20 is at most 95%, at most 90%, at most 85%, or at most 80% of a peak flux incident upon the target. This peak flux may be for a given day as a per-day peak flux, a given month as a per-month peak flux, or a given year as a per-year peak flux. Typically, the non-dumping period of time is not at night or in a no-insolation or extremely low insolation period of time. During the non-dumping period of time, the amount of flux may be at least 15%, at least 20%, at least 30%, at least 40%, at least 50%, or at least 60% of the peak flux incident upon the target at or near the top of the tower. For example, the non-dumping periods of time may occur early in the morning, late in the afternoon, and/or during the winter. However, this is not a limitation, and may depend on one or more physical parameters of the solar power system.

When referring to a square grid with respect to the disclosed embodiments, a square grid within a square can be aligned with the corners if the corners of the square are grid points. The distance between horizontally and vertically adjacent grid points is the grid parameter of the square grid. An x % square grid within an enclosing square has a grid parameter whose length is x % of the length of a side of the enclosing square. For example, a 1% square grid that is aligned with the corners of an enclosing square given by points {(x₁,y₁), (x₁,y₂), (x²,y₁) and (x₂,y₂)} will have grid points at {(x₁,y₁), (x₁+0.01*(x₂−x₁),y₁, (x₁+0.02*(x₂−x₁),y₁) . . . (x₁+0.99*(x₂−x₁),y₁), (x₂,y₁), (x₁,y₁+0.01*(y₂−y₁)), (x₁+0.01*(x₂−x₁),y₁+0.01*(y₂−y₁)), etc.}.

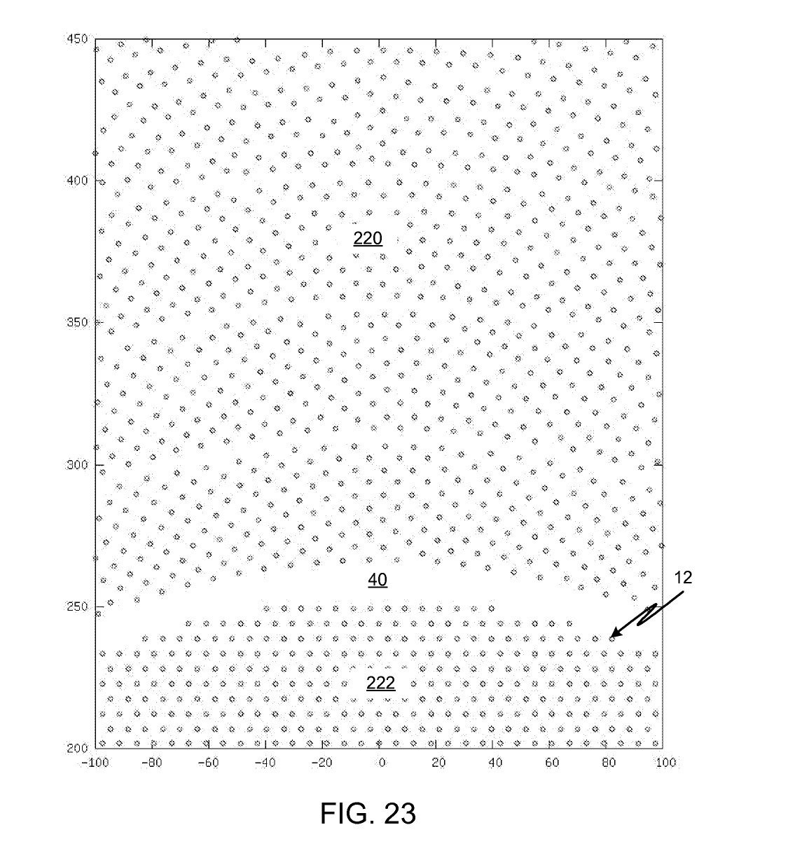

FIG. 3 is a schematic diagram representative of a solar field with heliostats 12, each configured to track the sun and re-direct insolation to the central tower 18. For example, the solar field can include over 50,000 heliostats, although other numbers of heliostats are also possible according to one or more contemplated embodiments. The solar field 16 may include one or more radially directed drive zones 42. A circumferentially directed drive zone 40 may divide an outer portion 220 of heliostats 12 from an inner portion 222 of heliostats 12 close to the tower 18. FIG. 23 shows a close-up view of a portion of the field 16 showing, in particular, that heliostats 12 in the interior portion 222 have a different arrangement than those in the exterior portion 220.

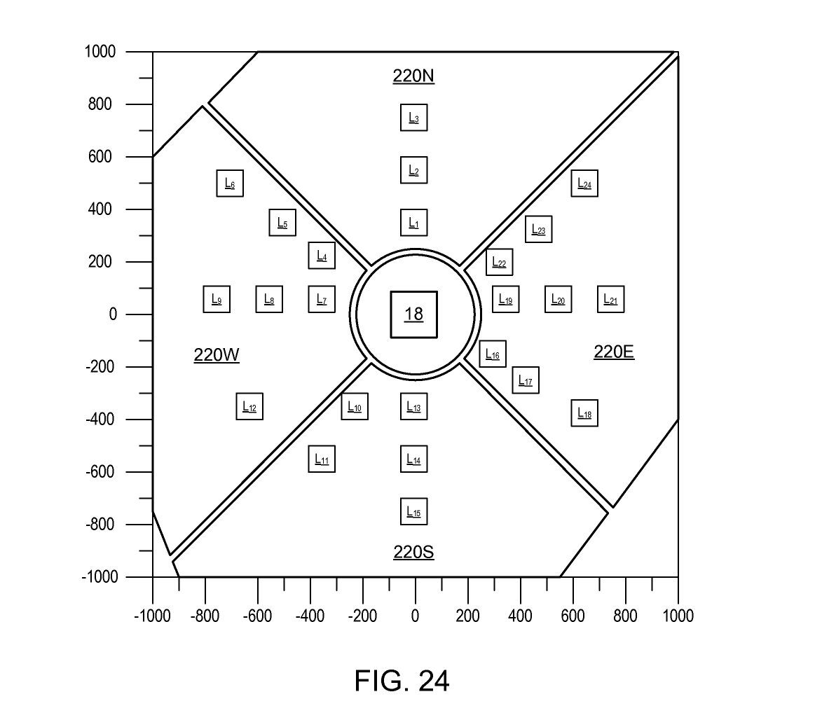

FIG. 24 identifies twenty-four different locations in the solar field 16 for discussion below with regard to heliostat density. Each location can be, for example, 100 m². Three locations, L₁-L₃, can be arranged along a substantially northern direction in a northern section 220N of the field. Three locations, L₄-L₆, can be arranged along a substantially northwestern direction, for example, in a western section 220W of the field. Three locations, L₇-L₉, can be arranged along a substantially western direction in the western section 220W of the field. Three locations, L₁₀-L₁₂, can be arranged along a substantially southwestern direction, for example, partly in the western section 220W of the field and partly in a southern section 220S of the field. Three locations, L₁₃-L₁₅, can be arranged along a substantially southern direction, for example, in the southern section 220S of the field. Three locations, L₁₆-L₁₈, can be arranged along a substantially southeastern direction, for example, in an eastern section 220E of the field. Three locations, L₁₉-L₂₁, can be arranged along a substantially eastern direction, for example, in the eastern section 220E of the field. Three locations, L₂₂-L₂₄, can be arranged along a substantially northeastern direction, for example, in the eastern section 220E of the field.

The center for each of the locations closest to the tower, i.e., L₁, L₄, L₇, L₁₀, L₁₃, L₁₆, L₁₉, and L₂₂, can be at a distance from the tower 18 of, for example, approximately 350 m. The center for each of the locations farthest from the tower, i.e., L₃, L₆, L₉, L₁₂, L₁₅, L₁₈, L₂₁, and L₂₄, can be at a distance from the tower 18 of, for example, approximately 750 m. The center for each of the other locations, i.e., L₂, L₅, L₈, L₁₁, L₁₄, L₁₇, L₂₀, and L₂₃, can be at a distance from the tower 18 of, for example, approximately 550 m.

Table 2 below shows heliostat density values for the different locations identified in FIG. 24. The density values listed in Table 2 illustrates that heliostat density in different quadrants or parts of the field may be designed to vary, even if the locations are otherwise equidistant from the tower. In addition, a heliostat density ratio for locations similarly situated with respect to the tower may vary, for example, as function of distance from the tower. For example, a south-north heliostat density ratio may increase with distance from the tower.

To illustrate, locations L₁₃ and L₁ shows that the densities in the southern field 220S and the northern section 220N at the same distance are different. A south-north density ratio can be defined for locations similarly situated with respect to the tower 18 in the south section 220S and the north section 220N. In particular, for L₁₃ and L₁, a south-north density ratio is 2.32/2.09=1.11. Comparing the L₁₄ value and the L₂ value results in a south-north density ratio of 2/1.66=1.2. Comparing the L₁₅ value and the L₃ value results in a south-north density ratio of 1.62/1.25=1.3. Accordingly, with increasing distance from the tower 18, the south-north density ratio between similarly arranged locations (i.e., at equal distance from the tower 18) may increase.

TABLE 2
Density of Heliostats at Different Locations in Solar Field

| | Distance of | | Distance | | | |
|---|---|---|---|---|---|---|
| | ~350 m | | of ~550 m | | Distance of ~750 m | |
| | Refer- | Density | | Density | | Density |
| Sector of | ence | (per 100 | Reference | (per 100 | Reference | (per 100 |
| Field | No. | m²) | No. | m²) | No. | m²) |
| North | L1 | 2.09 | L2 | 1.66 | L3 | 1.25 |
| Northwest | L4 | 2.1 | L5 | 1.79 | L6 | 1.32 |
| West | L7 | 2.14 | L8 | 1.88 | L9 | 1.52 |
| Southwest | L10 | 2.31 | L11 | 2.02 | L12 | 1.65 |
| South | L13 | 2.32 | L14 | 2 | L15 | 1.62 |
| Southeast | L16 | 2.16 | L17 | 1.83 | L18 | 1.43 |
| East | L19 | 2.08 | L20 | 1.75 | L21 | 1.4 |
| Northeast | L22 | 1.98 | L23 | 1.58 | L24 | 1.34 |

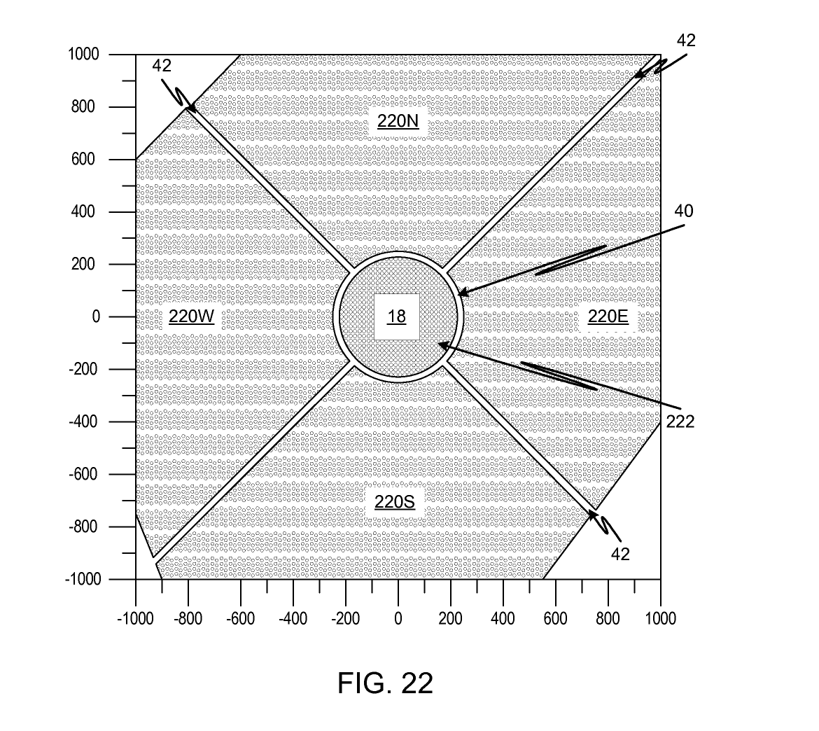

The heliostat density in a southern portion of the solar field may exceed the heliostat density in the northern portion of the solar field. The embodiment described in FIGS. 22-24 and Table 2 is applicable to solar fields in the northern hemisphere. In the southern hemisphere, this result would be reversed. In other words, in the southern hemisphere, the heliostat density in the northern portion of the solar field would exceed the heliostat density in the southern portion of the solar field.

In the northern hemisphere, southern heliostats may tend to be weaker than their similarly situated northern counterparts due to cosine effects. In contrast, in the southern hemisphere, northern heliostats may tend to be weaker than their similarly situated southern counterparts due to cosine effects. It may be advantageous then to deploy heliostats at an increased density in regions with weaker heliostats (relative to the regions with stronger heliostats) in order to provide additional insolation-reflection capacity to compensate or at least partially compensate for the weakness. Additionally or alternatively, the weaker heliostats may include larger mirrors.

In addition, a west-east density ratio can also be defined. To illustrate, locations L₇ and L₁₉ shows that the densities in the western section 220W and the eastern section 220E at the same distance are different. A west-east density ratio can be defined for locations similarly situated with respect to the tower 18 in the western section 220W and the eastern section 220E. In particular, for L₇ and L₁₉, a south-north density ratio is 2.14/2.08=1.03. Comparing the L₈ value and the L₂₀ value results in a south-north density ratio of 1.88/1.75=1.05. Comparing the L₉ value and the L₂₁ value results in a south-north density ratio of 1.52/1.4=1.08. Accordingly, with increasing distance from the tower 18, the west-east density ratio between similarly arranged locations (i.e., at equal distance from the tower 18) may increase.

The heliostat density in the western portion 220W of the solar field may exceed the heliostat density in the eastern portion 220E of the solar field. Electrical tariffs for electricity in the afternoon period may be greater than electrical tariffs for electricity in the morning period. Accordingly, the placement of heliostats, for example, as described herein, may be optimized to maximize afternoon electricity production and/or afternoon insolation to the tower 18 in order to maximize the revenue or to maximize a revenue/field cost function. Such a revenue/field cost function may take into account the density or number of heliostats and/or aggregate size of mirrors or mirror density, for example, in some sort of ratio or other function that captures revenue per heliostat or mirror capital cost. This maximization of afternoon electricity production and/or maximization of afternoon insolation to the tower may come at the expense of morning electricity production and/or morning insolation to the tower because the total number of heliostats and/or total amount of mirror area that may be deployed in the solar field may be fixed and/or constrained.

When designing a solar field for preferential production of afternoon power with a limited number of heliostats (for example, due to budgetary or geographic constraints), a greater number of heliostats may be arranged in the western portions of the field than the eastern portions. Even though the heliostats in the western section of the field may be weaker in terms of the amount of tower-received insolation as compared to similarly situated heliostats in the eastern section of the field, the arrangement of heliostats may be to prefer these weaker western heliostats for the purpose of generating elevated levels of afternoon electricity.

To design a solar field, a cost function can be established that constrains the total number of heliostats and/or total mirror area that can be deployed in a north-south field that includes northern portions and southern portions. The solar field may be required to have elevated afternoon production of electricity and/or elevated aggregate reflection of insolation to a target associated with a solar energy tower even at the expense of the morning electricity production and/or morning insolation redirection from heliostats to a solar tower target. In response to the cost function, a heliostat layout can be designed that specifies a deployment where there are more heliostats arranged in the southern portion of the field as compared to the northern portion of the field. The deployment may be according to any scheme and/or feature including, but not limited to, any combination of the schemes and/or features disclosed herein. Alternatively or additionally, a cost function can be used to design a solar field where more heliostats are deployed in the western section of the field than in the eastern section and/or at a greater density in the western section than in the east eastern section.

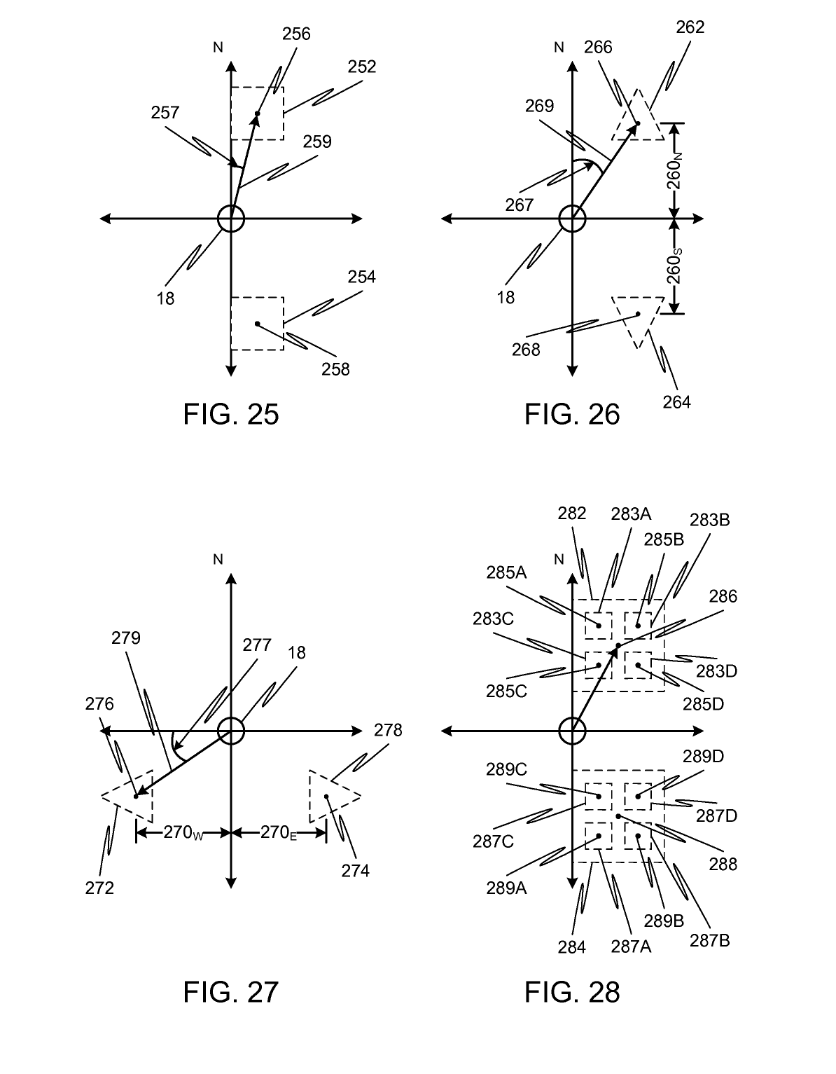

FIG. 25 represents regions of a solar field in which heliostats are deployed. One portion of the solar field can be a northern square-shaped region 252. Another portion of the solar field can be a southern square-shaped region 254, which is substantially a mirror image of the northern region 252 across an eastern axis centered at the tower 18. Both the northern region 252 and the southern region 254 can be aligned with the cardinal directions, i.e., the two vertical sides in the figure are parallel to the north-south direction while the two horizontal sides in the figure are parallel to the east-west direction. Both the northern region 252 and the southern region 254 can have substantially the same east-west offset, i.e., shift from the north-south axes centered at the tower 18. For the northern region 252, a deviation angle 257 may exist between a vector 259 from the center of tower 18 to the center 256 of the northern region 252. For the southern region 254, a similar deviation angle (not shown) can be defined between a vector (not shown) from the center of tower 18 to the center 258 of the southern region 254. Since the northern region 252 and the southern region 254 are north-south mirror images of each other, their deviation angle 257 is necessarily the same.

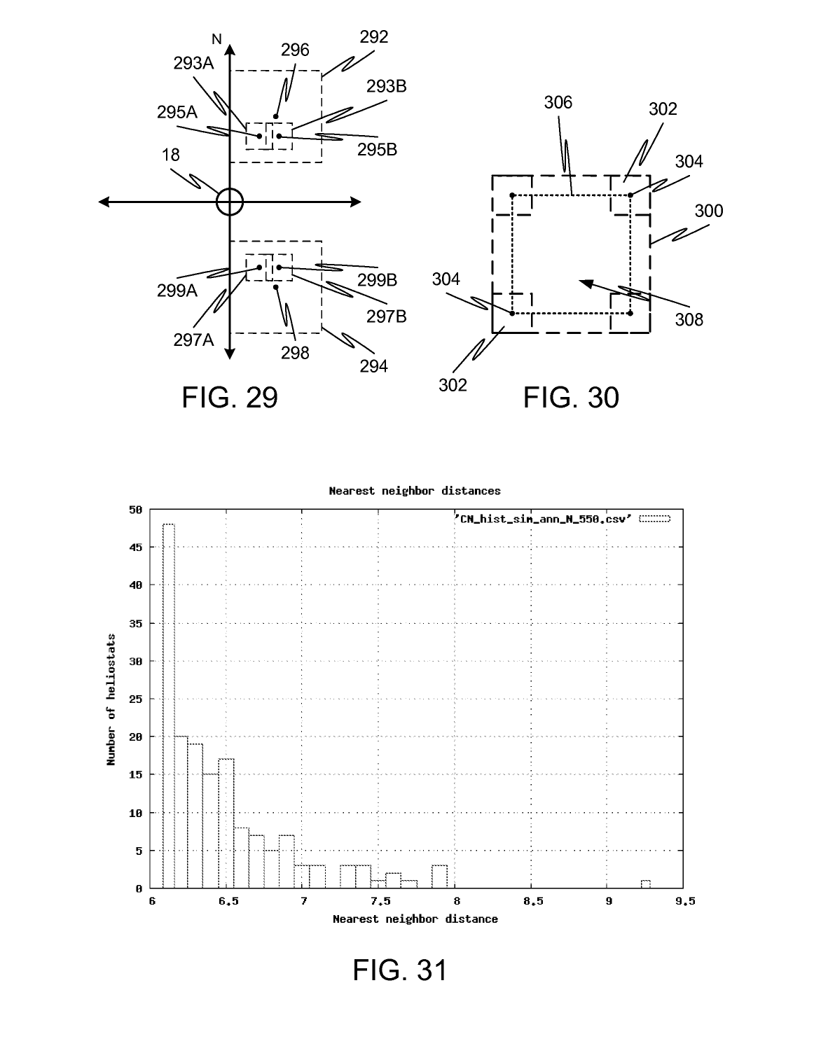

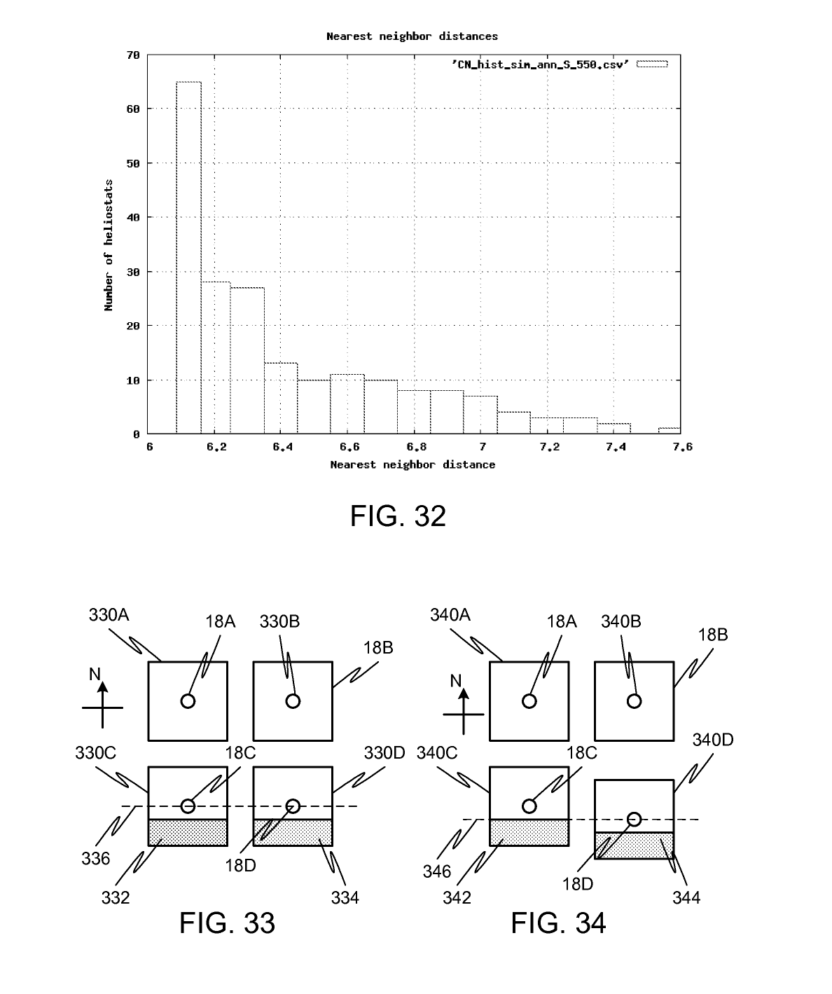

The concept of north-south and east-west mirror images is illustrated in FIGS. 26-27. For north-south mirror images of regions of land, the east-west deviation angle 267 is the same both for the original region of land, e.g., region 262 and its mirror image 264. For east-west mirror images of regions of land, the north-south deviation angle 277 is the same both for the original region of land, e.g., region 272, and its mirror image 278. As illustrated in FIGS. 28-29, it is possible to examine multiple sub-regions 283A-D, 287A-D, which may or may not be disjointed (see 293A-B and 297A-B in FIG. 29), entirely contained within the northern region 282 or southern region 284. For example, a smaller sub-region 283A within the northern square region 282 may be defined by a small square with a center 285A.

As shown in FIG. 30, in order for the region 302 to remain entirely within the larger region 300, the region 302 can only be located in positions defined by its range. The range of movement 308 of the small square 302 within the larger square 300 is bounded by the locus 306 of points within the larger square where region's center 304 can be located so that the region 302 remains entirely within the larger square 300. This range 308 denotes the set of possible positions of the small square's center 304.

The following paragraphs apply to tower-heliostat systems based in the northern hemisphere, where the total number of heliostats (or the aggregate mirror size of all heliostats) south of the tower exceeds the total number of heliostats (or the aggregate mirror size of all heliostats) north of the tower. For systems based in the southern hemisphere, the total number of heliostats (or the aggregate mirror size of all heliostats) south of the tower would exceed the total number of heliostats (or the aggregate mirror size of all heliostats) north of the tower. The description below can thus be applied to the southern hemisphere embodiment by interchanging the recitations of northern and southern to account for this feature.

Referring to FIG. 28, a first comparison can be made between the number of heliostats and/or aggregate mirror size of all heliostats within region 283A when its position within the northern region 282 and the number of heliostats and/or aggregate mirror size of all heliostats within the north-south mirror image 287A of small square 283A within the southern region 284. Additional comparisons can be carried out for the different mirrored regions within the north and south regions 282, 284, e.g., 283B with 287B, 283C with 287C, and 283D with 287D. Each comparison can involve the computation of, for example, the ratio of the total number of heliostats in the small square 283A to the total number of heliostats in the southern small square 287A and/or a ratio of the aggregate mirror size of all heliostats within the small square 283A to aggregate mirror size of all heliostats in the southern small square 287A.

As shown in FIG. 29, this comparison can be carried out when a first comparison relates to the regions 293A, 297A and a later comparison relates to the regions 293B, 297B, where the regions 293A, 293B (and therefore 297A, 297B) overlap each other. Referring to FIG. 30, it is also possible to slide a region 302 throughout the entirety of its range 308, for example, by moving the region 302 an infinitesimal amount to cover the entire range, such that each point of range 308 is visited by the center 304 of region 302 only once. For each point within range 308 where the center 304 of region 302 can be located, there is a north-south mirror image location of the center 304 of region 302, e.g., within southern region 294.

For each visited position of the center 304 of region 302 within the range 308, another comparison of total number of heliostats and/or total mirror size in the northern version of region 302 versus the total number of heliostats and/or total mirror size in the southern version of region 302. This can be carried out for the large or even infinite number of positions within range 308. Thus, it is possible to effect a number of comparisons. In some embodiments, a comparison may be performed each time the center 304 of region 302 is moved. Alternatively or additionally, the center 304 of region 302 can be restricted to movements equal to 5%, 1%, 0.1%, or 0.01% of a dimension of the range 308, i.e., the length of a side of the square defined by range 308.

Based upon this movement distance, it is possible to discuss a set (for example, a large set) of one-by-one comparison between the northern sub-region and its southern mirror counterpart according to the positions within range 308. For this set of comparisons, a majority of the comparisons in the set may exhibit one or more of the following features: (1) the number of heliostats in both the northern sub-region and the southern sub-region is at least 2, 3, 5, or 10 heliostats, or at most 12, 10, 7, 5, or 3 heliostats; (2) a ratio between the total number of heliostats in the southern region, e.g., region 287A, to the total number of heliostats in the northern region, e.g., region 283A, is at least 1.01, 1.02, 1.03, 1.04, 1.05, 1.06, 1.07, 1.08, 1.09, 1.1, 1.12, 1.14, a 1.16, 1.17, 1.18, 1.19, or 1.2; (3) a ratio between the aggregate size of the total number of heliostats in the southern region, e.g., region 287A, to the aggregate size of the total number of heliostats in the northern region, e.g., region 283A, is at least 1.01, 1.02, 1.03, 1.04, 1.05, 1.06, 1.07, 1.08, 1.09, 1.1, 1.12, 1.14, a 1.16, 1.17, 1.18, 1.19, or 1.2. For example, in the FIG. 28, a single comparison can compare the total number of heliostats or aggregate mirror size of all the heliostats in regions 283A and 287A, a second comparison can be between regions 283B and 287B, a third comparison can be between regions 283C and 287C, and a fourth comparison can be between regions 283D and 287D.

A parameter α may be defined for a given location in the solar field. In particular, the parameter α may define a ratio between a distance between the given location and the tower, and a height of the central tower and/or of the target at or near the tower of the tower. Locations with a larger a may generally be further from the tower. For example, for a larger field (i.e., greater than 50,000 heliostats) and a tower height of between approximately 130 m and 140 m, when distance to the tower from a specific location is 550 m, then the a parameter may be between about 3.9 and about 4.25. In embodiments, a majority, a substantial majority, or even an entirety of the northern region 252 and the corresponding southern region 254 may have an alpha value that exceeds 2.5, 2.7, 3, 3.25, 3.5, 3.75, 4, 4.25, 4.5, 4.75, 5, 6, 7, 8, 9 or 10.

FIGS. 15A-15B illustrate the variation in densities in different regions. FIG. 15A represents the number of heliostats in the northern field while FIG. 15B represents the number of heliostats in the southern field. Each heliostat has a distance to the nearest neighboring heliostat that would be indicative of the relative density within the field. In FIGS. 15A-15B, the number of heliostats for each nearest neighbor distance (in meters) has been plotted. As should be apparent from FIGS. 15A-15B, a difference exists between the heliostat arrangement in the northern field and the southern field.

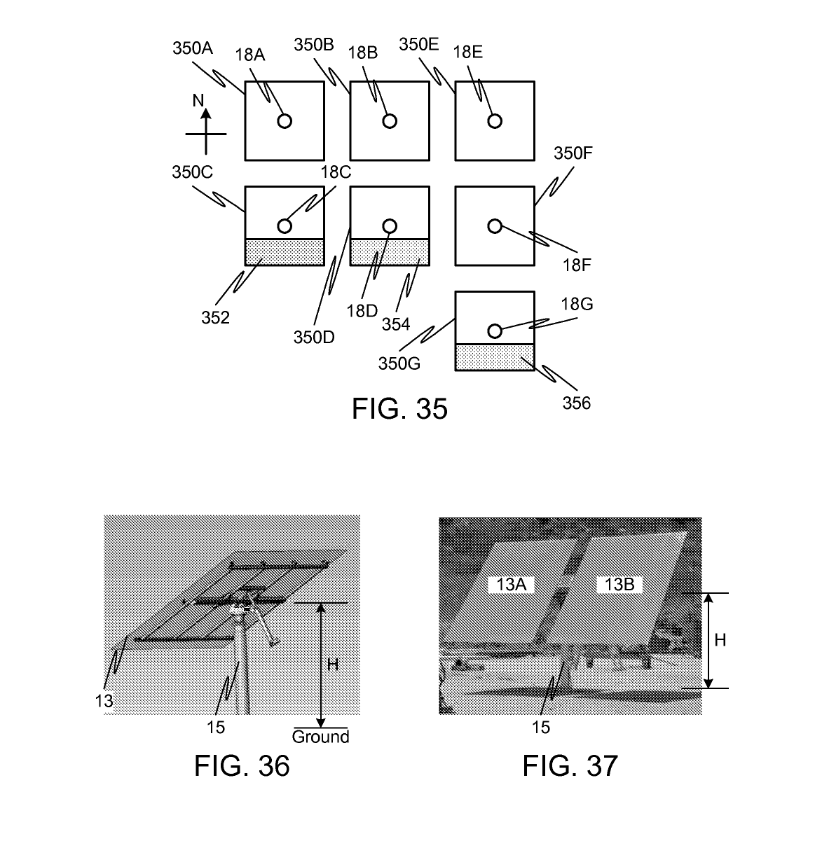

In embodiments, co-located multiple single-tower solar fields can be provided at a single geographic location, as shown in FIG. 33. For example, four towers 18A-18D with respective solar fields 330A-330D can be provided. In embodiments, each field 330A-330D may be associated only with its tower 18A-18D. Heliostats within each field may be configured only to redirect insolation to its respective tower, i.e., heliostats in field 330A would be configured to only re-direct insolation to tower 18A. The southern-most regions 332, 334 in fields 330C, 330D may be south of all towers 18A-18D, defined by line 336. Various principles disclosed herein can be applied to any field 330A-330D or combination of fields. FIGS. 34-35 illustrate other configurations for co-location of towers and solar heliostat fields. In the example of FIG. 35, certain field portions 352, 354 are considered southernmost for a particular row of solar fields 350C, 350D, 350F. In embodiments, a ratio between the distance between any heliostat or region of heliostats and its respective tower, and the distance between any heliostat or region of heliostats and another of the towers may be less than 0.9, 0.7, 0.5, 0.3, 0.2, 0.1, or 0.05.

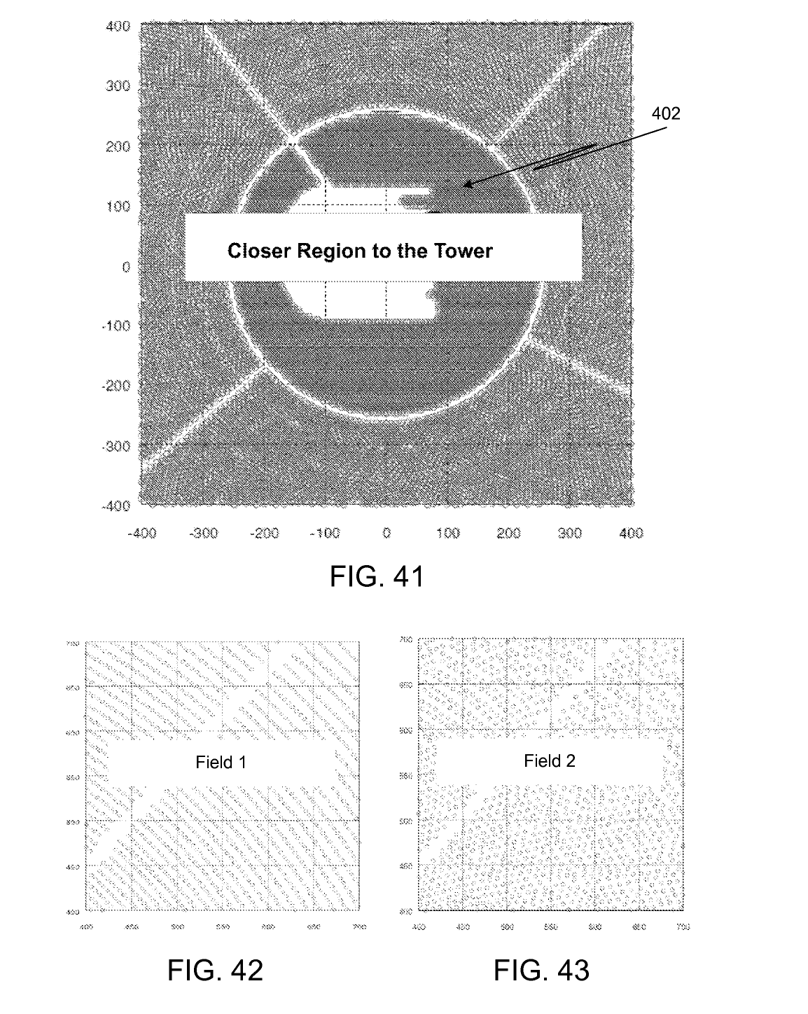

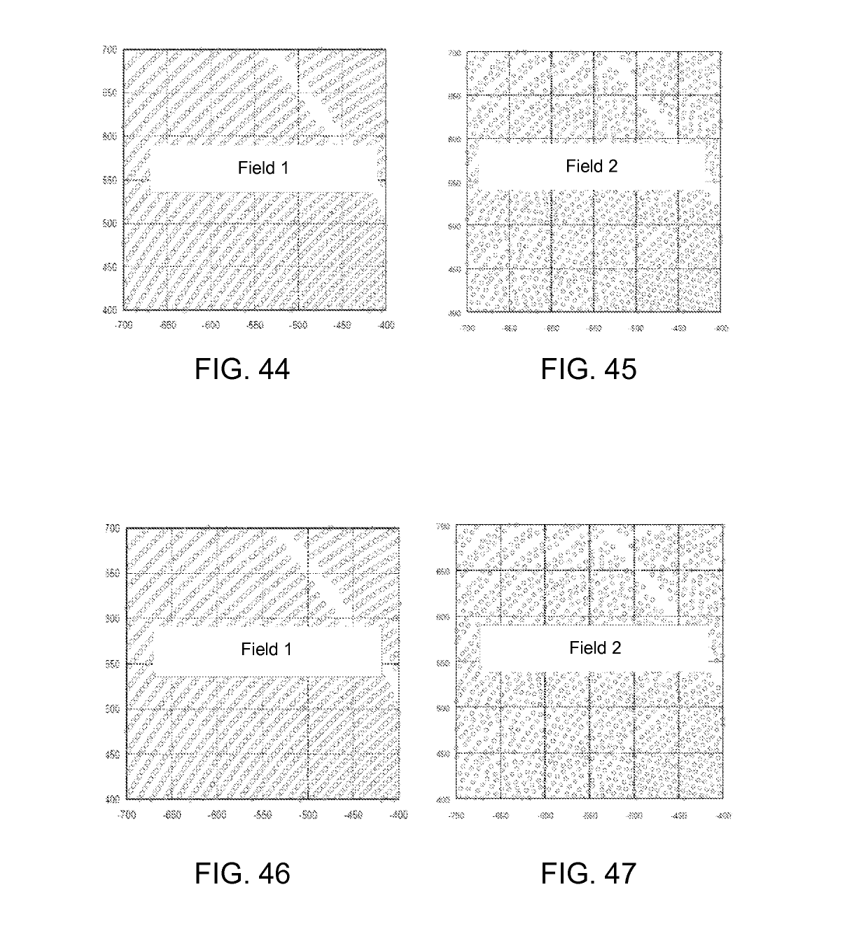

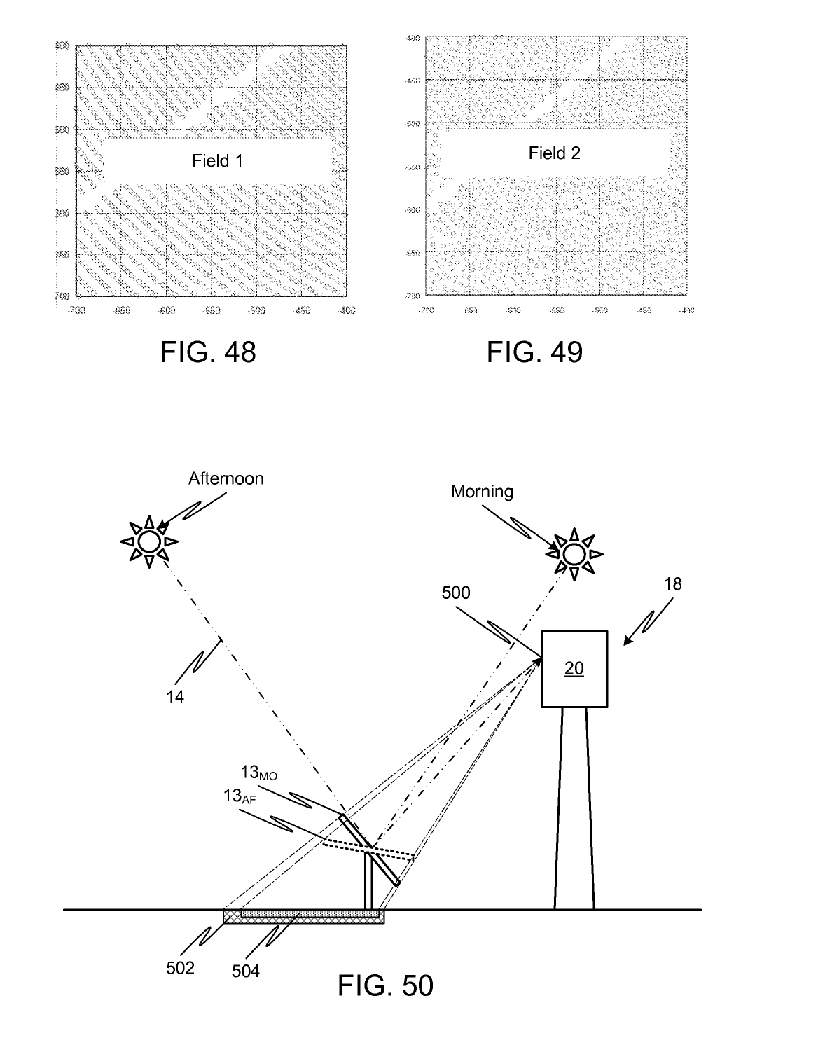

A point-schematic diagram of a solar field is a to-scale diagram describing heliostat layout in the solar field whereby individual heliostats are represented by single dots, each respectively located at the respective heliostat location (see, for example, FIGS. 41-49). Although some point-schematics often include virtual connecting lines or arcs describing the arcs or lines on which heliostats are deployed, there is no requirement as such.

A dominant observable layout pattern in some point-schematic diagrams of solar field is where most or all heliostats within in non-local regions of the solar field are an in arc layout pattern, which is typically very ordered. According to these layouts, within non-local regions having the arc layout heliostat deployment scheme, there is generally no visually discernable disorder observable within these non-local regions in their point-schematic diagrams. In other examples, the heliostat layout may be constrained so that heliostats are deployed at regular intervals on straight lines that traverse significant, non-local portions of the solar field. In both cases, the heliostats can be deployed in regular intervals on the lines or on the arcs/curves. Thus, deployment of heliostats at substantially regular intervals on lines or curves/arcs contributes to the lack of visually discernable disorder observable in the point-schematic diagram.

In order for the heliostat layout to be considered line- or arc-pattern dominant, it is generally clearly discernible to the naked eye viewing a point-schematic diagram that the heliostats are regularly deployed on an arc or curve, such as shown in FIGS. 2, 38, 39, or on parallel lines. The heliostats may be deployed at regular intervals for significant regions of the total heliostat deployment around a given tower, and not just for small localized regions within a sub-total of heliostats deployed around a centralized tower, to be considered ordered-pattern dominant.

In embodiments, the efficiency of a solar tower system can be optimized by deploying some, most, or substantially all of the heliostats that are relatively far from the tower in a manner such that these far heliostats are arranged in a pattern generally considered disordered. For example, the far heliostats may be distributed in a manner not constrained to situations where a line pattern or an arc pattern that is consistent over non-local regions is the dominant layout pattern and/or not constrained to a highly ordered layout patterns lacking any significant visible degree of disorder. By relaxing such constraints, and by employing one or more optimization routines (i.e., where the routines may enjoy more degrees of freedom, over significant regions of the solar field but not necessarily an entirety of the field), improved efficiency may be realized over more ordered layout schemes.

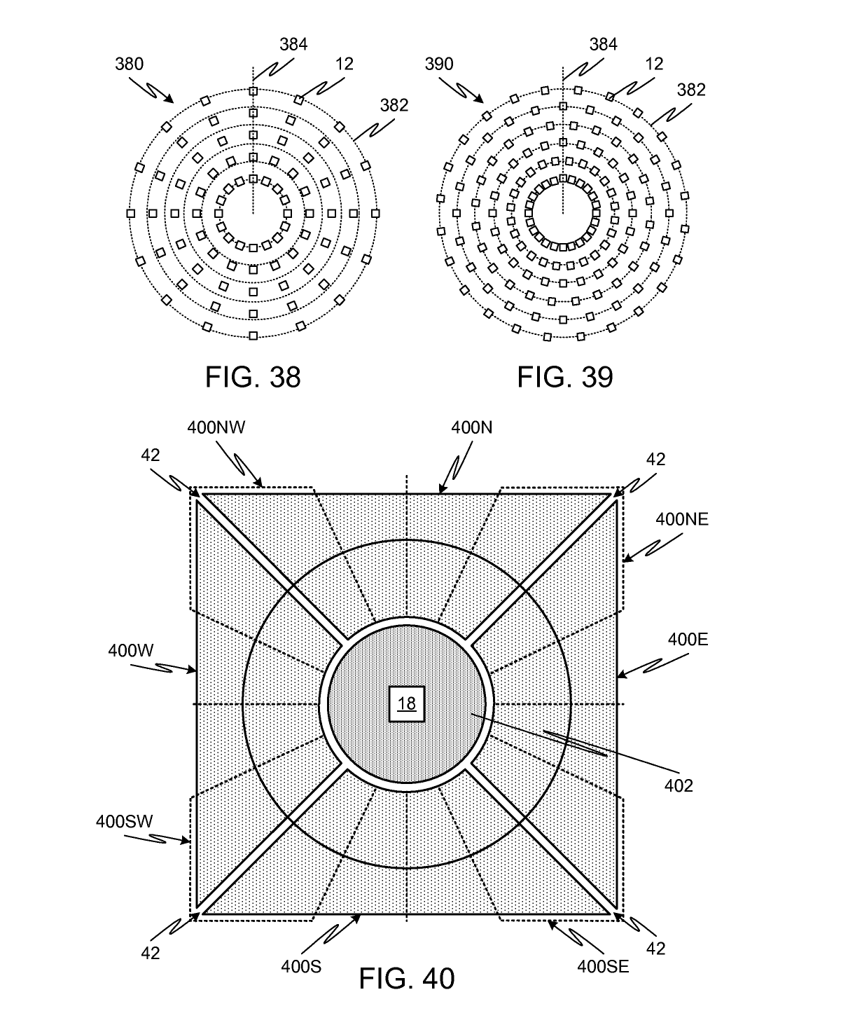

Heliostats may be arranged in a manner that facilitates higher efficiency conversion of insolation into a useful form of energy such as steam, electricity, and biomass. FIGS. 38-39 relate to a highly-constrained and/or highly-ordered layout patterns. In contrast, embodiments may include regions in which a highly-constrained and/or highly-ordered layout is avoided in favor of optimizing heliostat layout geometry, which may appear disordered. Thus, when viewing a point-schematic diagram of a solar field on a larger scale (as opposed to considering only small localized regions within the significant region of heliostat layout) there is a visible and clearly-discernible amount of disorder in the layout pattern and/or there is no discernible dominant line pattern or dominant arc pattern over large non-local distances that are only a fraction of the significant regions.

By removing the constraints requiring the larger-scale line or arc patterns, even though the field layout may be less aesthetically appealing, it is possible to obtain a more efficient heliostat layout. Efficiency may relate to the total intensity or amount of insolation directed to the receiver in a tower as a function of the capital investment cost. For example, efficiency may be measured as the total reflection capability divided by some measure of the total area of the mirrors of the heliostats. In addition, the relatively disordered field may be more difficult to maintain due to the lack of predefined pathways through the heliostat field. The use of conditional drive zones in these disordered regions may allow the use of the disordered pattern while allowing access to heliostats in these regions by a maintenance vehicle.

Without the requirement for an ordered pattern, the layout resulting from a large-scale optimization routine may exhibit one or more of the following features:
(1) When viewing the point schematic of the field (or a significant portion of the field), it is clear that there is a noticeable level of entropy of disorder compared to a global line-layout and/or a global arc-layout (or combinations thereof). This visibly disordered or semi-disordered pattern throughout non-local regions of the solar field can be a salient feature. For example, the outer region of a field of heliostats may be disordered or semi-disordered. This outer region may be a distance that is at least 2 times, 2.5 times, 3 times, 3.5 times, or 4 times the height of the central tower.
(2) Even though the overall layout pattern of these regions may appear disordered, there is no requirement for pure disorder. Instead, it may be possible to observe a certain number of localized patterns. For example, there may be some sort of localized broken zigzag pattern of heliostats where there are numerous heliostat zigzag clusters that are broken relative to each other deployed throughout the field.

In embodiments, methods for computing a heliostat layout can include global optimization, metaheuristic, and/or other computational techniques. Such computation of the heliostat layout may be in a manner where the heliostat layout is substantially free from the constraints associated with ordered or arc/line-dominant patterns over a non-local region of the field. The resulting heliostat layout may be characterized by a relatively high heliostat field insolation-redirection efficiency parameter.

FIGS. 38-39 are representative of a first field (“Field 1”) ordered layout 380, 390, where a majority of the heliostats 12 are deployed in concentric circles 382 around the centralized tower. FIGS. 40-41 are representative of a second field (“Field 2”) in which different arrangements of heliostats may exist in different portions of the field. In particular, the second field may have heliostats arranged in a generally disordered arrangement, as discussed above. In both Field 1 and Field 2, although a certain number of heliostats are illustrated in the figures, the number of heliostats can be over 50,000 deployed in a solar field that is approximately 4 km². The heliostats may have the same shape, size, and height. Both fields can feature four radial access roads 42 that lead to the tower 18.

FIGS. 42-49 illustrate the contrast between an arc-layout of Field 1 (i.e., FIGS. 42, 44, 46, and 48) and the relatively disordered layout of Field 2 (i.e., FIGS. 43, 45, 47, and 49). In particular, FIG. 43 represents a northeast portion 400NE of the field, FIG. 45 represents a northwest portion 400NW of the field, FIG. 47 represents a southeast portion 400SE of the field, and FIG. 49 represents a southwest portion 400SW of the field. It should be apparent that a visible and significant amount of disorder is clearly visible in the figures, even though these figures are not point-schematic diagrams (the pattern would be equally observable from such a point-schematic diagram).

In Field 2, there may be a difference in the arrangement between heliostats proximal to the tower 18, for example, in central region 402, and heliostats distant from the tower 17, for example, in outer regions 400. A distant heliostat can be defined as a heliostat whereby a ratio between the tower-heliostat distance and the height of the tower is at least 2, 2.5, 3, 3.5, 4, 4.5, 5, 7.5, or at least 10. Within this central region 402, heliostats may be arranged in a more ordered, relatively dense arrangement, while heliostats in the outer regions 400 may be substantially disordered.

Multi-region schemes can be developed wherein for regions close to the tower 18, e.g., region 402, heliostats are deployed in some sort of regular grid pattern. This regular grid pattern, or other types of packing patterns, can improve and/or maximize heliostat packing even at the expense of using too many heliostats or too much aggregate mirror area to maximize a per-mirror area metric. In these close regions, the dominant heliostat layout pattern may be a very ordered grid pattern such as a triangular grid pattern or a hexagonal close packed pattern.

For regions further from the tower 18, e.g., regions 400, where the heliostats are distant from the tower 18, a much less ordered heliostat layout scheme or an irregular/disordered scheme may be used. When a layout pattern exhibits a significant amount of irregularity and/or disorder this means that the irregularity and/or disorder are clearly discernible upon viewing a point-schematic diagram of a solar field. However, this does not require a mostly-disordered or completely-disordered layout scheme. In embodiments, the disordered layout features may co-exist with one or more additional features discernible from the point-schematic diagram of a solar field.

In embodiments, by optimizing heliostat layout for ground coverage as viewed from a location at or near the top of the tower (or any other above ground location) and by not constraining heliostat layout to require deployment of heliostats on lines or regular arcs/curves (or by requiring heliostat layout on lines or arcs but not further constraining the layout so as to require layout of most heliostats at regular intervals on the lines or arcs), it is possible to achieve a relatively high level of mirror-induced ground obscuring for a given heliostat density and/or mirror density. This relatively high level of ground coverage by heliostats at one or more locations in the solar field may be useful for facilitating a more efficient conversion of solar radiation into useful energy.

The concept of ground coverage is discussed below with reference to FIGS. 50-52. When viewing a certain area of the field from a particular viewing location 500, for example, at or near the top of the solar tower 18, certain portions of the ground will be visible from the viewing location 500, while other portions of the ground will be obscured by mirrors 13 of heliostats 12 directed to the target/viewing location 500. The viewing location 500 may correspond to the location on the target 20 to which the heliostats 12 reflect insolation while tracking the sun. When a certain region of the solar field is more crowded with a larger number of heliostats and/or heliostats having larger mirror areas, this may lead to a situation where ground coverage is higher.

Other than heliostat density and/or mirror density, ground coverage for a specific area of the solar field in which heliostats are deployed may depend on a number of additional factors, including, but not limited to: (1) the time of the day and/or day of the year; (2) the geographical location of the solar field; (3) the actual heliostat layout of the portion of the solar field for which ground coverage is being analyzed (e.g., the geometry of the heliostats, such as the distance between heliostats, angles of vectors connecting heliostats, or any other aspect of heliostat layout); (4) the size, shape, or height of each heliostat; (5) the height of the tower (or the height of the viewing location whose height and position is made to coincide with the location of the solar target); and (6) the distance of the portion of the solar field (i.e. for which ground coverage is being determined or analyzed).

In embodiments, ground coverage can be analyzed at one or more locations in the solar field for one or more times of the day and/or one or more times of the year. For example, one or more heliostat layouts can be analyzed and assigned a score according to the ground coverage provided by the heliostat layout. For example, the viewing location can be a location of the solar target at or near the solar tower. The score may be assigned according to a selected time of the day or year, or according to some time-average or weighted time-average. Alternatively or additionally, the score may be computed by analyzing the ground coverage in multiple locations in the solar field. For a given number of heliostats and/or a given amount of mirror to be deployed in a given area of land, there may be number of potential heliostat layouts. When heliostats are not restricted to deployment on lines or regular arcs/curves, the number of potential heliostat layouts may indeed be quite large. Each of these potential heliostat layouts may be associated with a different ground coverage score.

Embodiments described herein can relate to techniques for generating a solar field design describing the locations of at least some of the heliostats in a central-tower solar thermal plant. A search of the space of heliostat configurations can be performed to analyze various ground coverage or other parameters derived from ground coverage. The search space, which corresponds to the space of possible heliostat layout schemes, may be quite large. Rather than attempting to employ a brute force technique, a global optimization algorithm can optimize the locations of at least 50, 100, 500, 1000, 5000, or more of the heliostats in the field.

An optimization tool may be employed to obtain an approximation of a global optimum for a given ground-coverage-derived function in the large search space of heliostat layouts or for certain portions of the heliostat field. Optimization tools can include, but are not limited to, global or local search stochastic/probabilistic tools, metaheuristic algorithms, genetic algorithms, simulated annealing algorithms, hill-climbing algorithms, genetic algorithms, dynamic programming, and/or ant colony algorithms. A ground-coverage-derived function can include a time-averaged total ground coverage throughout the field or a region of the field. This time-averaged ground coverage function may be a weighted function giving preference to greater ground coverage in the summer months and/or in the late afternoon hours at the expense of other times of the day and/or other days of the year.

In embodiments, a method for determining a solar field layout can include first selecting one or more portions of the solar field for heliostat placement. Locations can be determined for a group of heliostats, such as heliostats within a larger area of the solar field, such area constituting is at least 50%, 70%, 80%, or 90% of the solar field. Using one or more optimization techniques, a field layout scheme for the selected portions of the solar field can be generated. Subsequently, heliostats may be installed in the solar field according to the generated layout scheme.

The generation of the field layout scheme may be such that ground coverage or ground obscuring by heliostats as viewed from a location at or near the top of the tower can be optimized. Ground coverage/obscuring may be just one metric of the overall ability of heliostats in a region of the solar field to re-direct insolation to the top (or near the top) of the solar tower. Other metrics may also be used. Additionally or alternatively, for one or more non-local regions of the solar field, such as regions of the solar field that are relatively distant from the tower, when optimizing the layout scheme for the one or more portions of the solar field, significant amounts of clearly discernible disorder may be introduced into the layout scheme.

FIGS. 50-52 may relate to western heliostats that are located to the west of tower 18 and viewing location/target point 500, although similar inferences may be drawn for heliostats in other sections of the solar field. Referring now to FIG. 50, because the heliostats 12 track the sun to reflect insolation 14 onto a target point 500 on the receiver 20, the orientation (e.g., elevation and/or azimuth) of mirror 13 of heliostat 12 changes throughout the daytime, from an orientation 13_{MO} in the morning to an orientation 13_{AF} in the afternoon.

The presence of the mirror 13 of heliostat 12 will obscure the ground as viewed from viewing location 500. Due to different orientation of the heliostat at different times of the day, the size and/or location of an obscured region can change for a given heliostat 12. For example, due to the orientation of the mirror 13_{MO} in the morning, an obscured region 502 is generated with respect to the viewing location 500, while the orientation of the mirror 13_{AF} in the afternoon may result in a smaller obscured region 504. For any time of the day in the northern hemisphere, the size of a ground obscured region caused by a lone heliostat at a given distance due north of the tower may be greater than the size of the ground obscured region that would be caused by the same lone heliostat if deployed at the same distance due south of the tower. In the southern hemisphere, this situation would be reversed such that the southern heliostats may cause more ground obscuring per heliostat than corresponding northern heliostats.

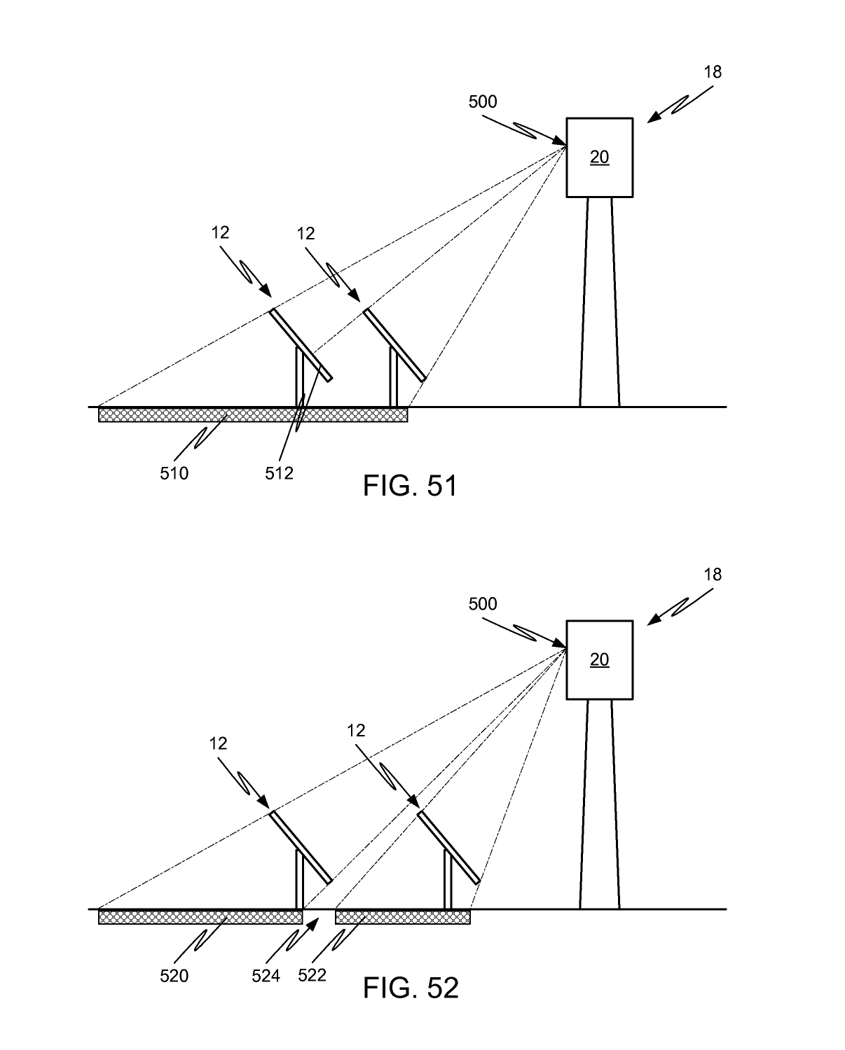

FIG. 51 illustrates two heliostats 12 that are both deployed west of tower 18. A portion 512 of the mirror 13 is blocked by the adjacent heliostat 12 with respect to the viewing location 500. In other words, insolation reflected by this portion 512 would be blocked by the mirror 13 of heliostat 12 from reaching the viewing location 500. In addition, there may be overlap between the regions obscured by each mirror 13, thereby producing a single obscured region 510 on the ground.

By moving the heliostats farther apart, as shown in FIG. 52, the obscured ground regions produced by each mirror become separate and distinct regions 520, 522, with a gap therebetween. This gap 524 represents an area of ground that is not obscured by the heliostats in their current arrangement and orientation. As this gap would be visible from the viewing location 500, it may represent wasted space, i.e., ground real estate that is not used to direct insolation at the receiver although it could be by appropriate arrangement and orientation.

The portion of a mirror 13 that is blocked and/or the size of the obscured region, e.g., 510, and/or the distance between obscured regions, e.g., size of gap 524, may be used in the optimization of heliostat field layout. By not constraining the heliostat layout to regular consistent patterns and by effecting a ground coverage per density range optimization procedure that includes ground coverage considerations, an efficient heliostat layout may be obtained.

By refraining from imposing an arc or line constraint upon a solar field layout, the amount of ground obscuring heliostats (i.e., either at a point in time or time-averaged over one or more time periods) may be optimized. In embodiments, this may relate to the case where heliostat locations are allowed to significantly deviate from any lines or arcs that may define regular or ordered patterns within the solar field. Additionally or alternatively, the deployment of heliostats may be restrained to, for example, concentric arcs; however, the heliostat placement along each arc can be substantially irregular to a significant degree.

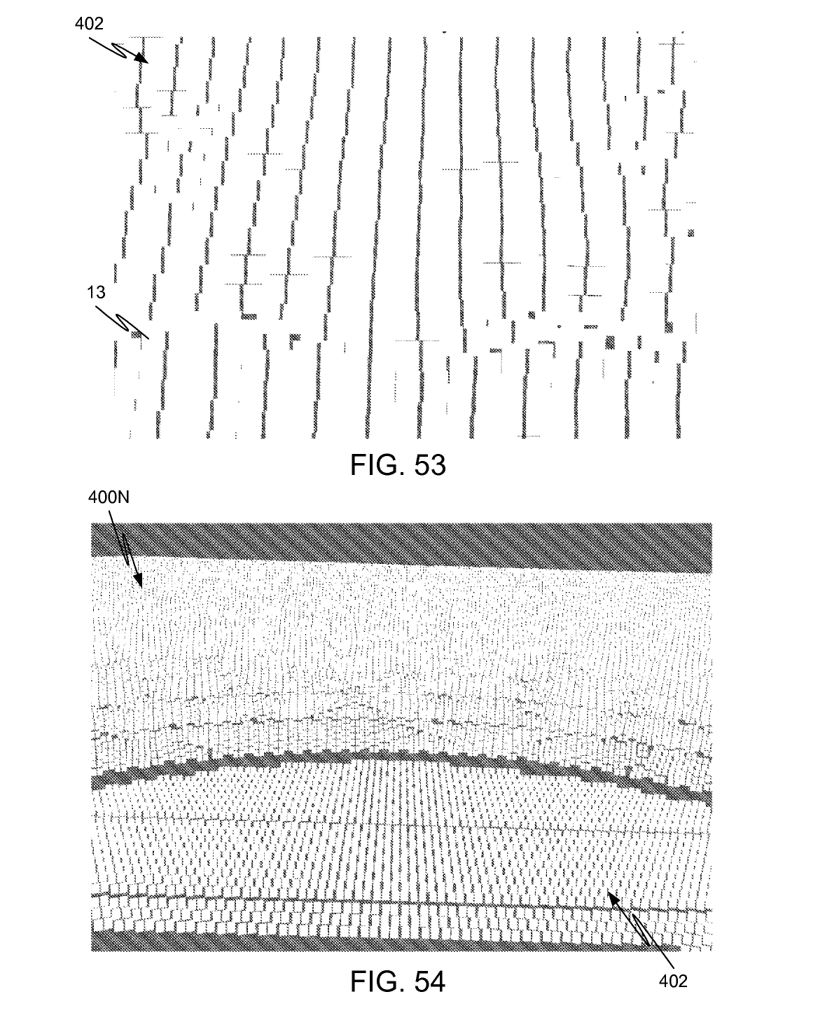

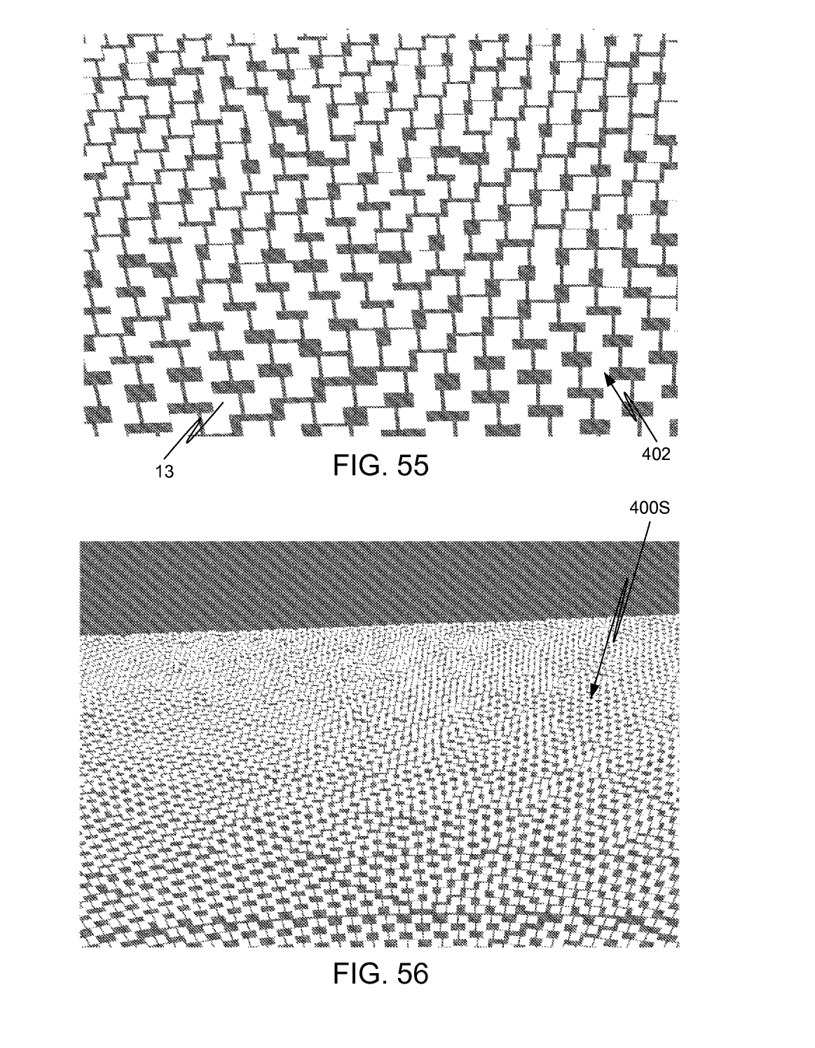

Referring now to FIG. 53, a view of a portion of the solar field, for example, a northern section of the inner portion 402 of Field 2 in FIGS. 40-41, as seen from a location at or near the top of a tower 18 is shown. FIG. 54 shows a portion of the solar field, for example, a northern section of the outer portion 400N of Field 2 in FIGS. 40-41. Similarly, FIGS. 55-56 illustrate a southern section of inner portions 402 and outer portions 400S of Field 2 in FIGS. 40-41. FIGS. 53-56 thus illustrate the ground obscuring nature of the arrangement of heliostats within the solar field. The solar field may appear much more ordered when viewed from the location at or near the top of the tower (i.e., because it is designed to maximize ground obscuring) than when viewed as a point-schematic diagram (i.e., an aerial view of the solar field).

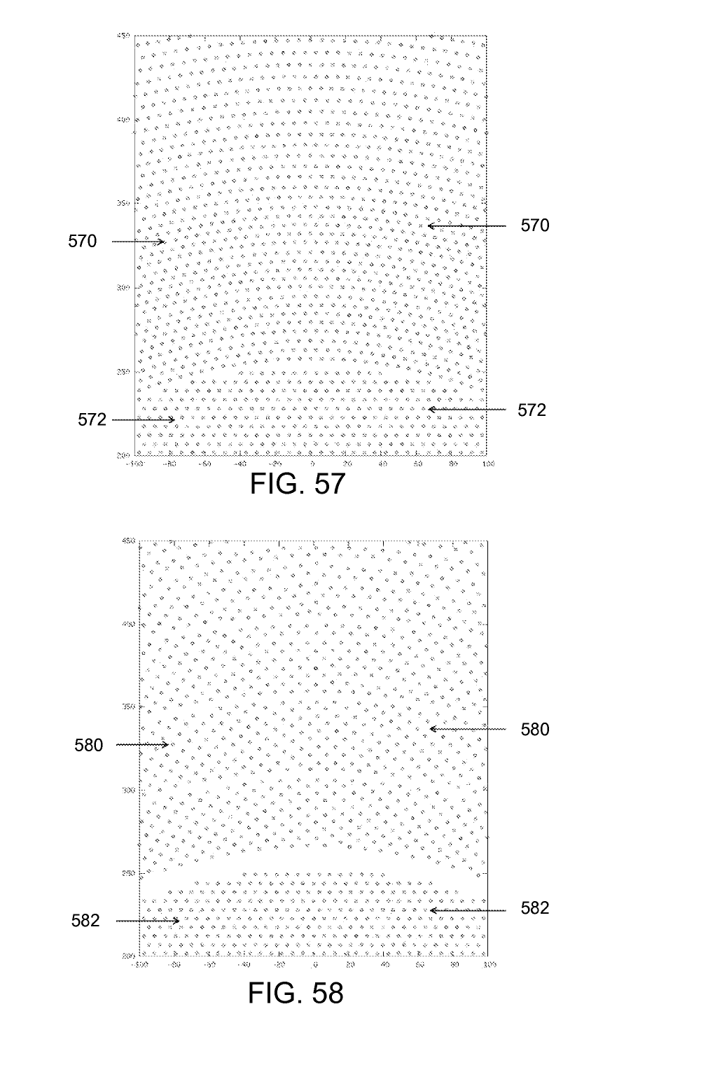

The region of the irregular and/or disordered heliostat placement can be restricted to an outer portion of the field, such as regions 400 of the solar field shown in FIG. 40. For example, in FIG. 58, the inner field 582 of Field 2 closer to the tower may be more ordered and/or conforming substantially to a grid layout while the outer field 580 may exhibit a significant amount of disorder while not necessarily being completely disordered. In comparison, the inner field 572 of Field 1 closer to the tower has a similar ordered pattern as the outer field 570, as shown in FIG. 57. In embodiments, the significant disorder feature may be mostly restricted to the outer portion of the field, while the mostly ordered feature can occur throughout most of an inner region proximal to the tower.

In embodiments, the solar field of heliostats may provide any combination of any feature disclosed herein, including but not limited to any combination of the following feature (for ranges, any combination of upper and lower limits defines a possible range):
(1) heliostat set size feature—for example, any feature may relate to a heliostat set of at least 10, 50, 100, 150, 200, 500, 1000, 3000, 5000, 10000, 20000, 50,000, or 100,000 heliostats in the solar field or a portion thereof;
(2) heliostat height feature—for example, any feature may relate to sets of heliostats wherein all, a majority, or a significant majority of a set of heliostats in any location are considered short. For example, the heliostat height, H, (i.e., the height of the centroid of the mirror assembly from the local ground) is at most 10 m, 7 m, 5 m, 3 m, 2.5 m, or 2 m. For example, a ratio between the heliostat height, H, to the tower height is at most 20%, 10%, 5%, 3%, 2%, 1.5%, or 1%;
(3) mirror size feature—for any set of heliostats of any size, the average mirror size may be, for example, at least 1 m², 3 m², 5 m², 10 m², or 12 m², or at most 50 m², m², or 20 m²;
(4) uniform mirror size—the heliostats have mirror assemblies that are substantially the same size or have a ratio between a standard deviation of mirror assembly sizes to the average mirror size of, for example, at most 0.5, 0.4, 0.3, 0.2, 0.1, 0.05, 0.03, 0.01, or 0.005;
(5) heliostat density—a set of heliostats can be deployed in an area of a solar field at a density (in heliostats per 100 m²) of at least 0.1, 0.3, 0.5, 0.75, 1, 1.5, or 2.5, or at most 10, 5, 3, 2, 1.5, or 1;
(6) mirror density—a set of heliostats can be deployed in an area of a solar field to provide a mirror density (i.e., the total area of mirrors of all mirror arrays of all heliostats within a given area divided by the size of the given area) of at least 1%, 5%, 10%, 15%, 20%, or 25%, or at most 70%, 50%, 30%, 20%, 15%, or 10%.

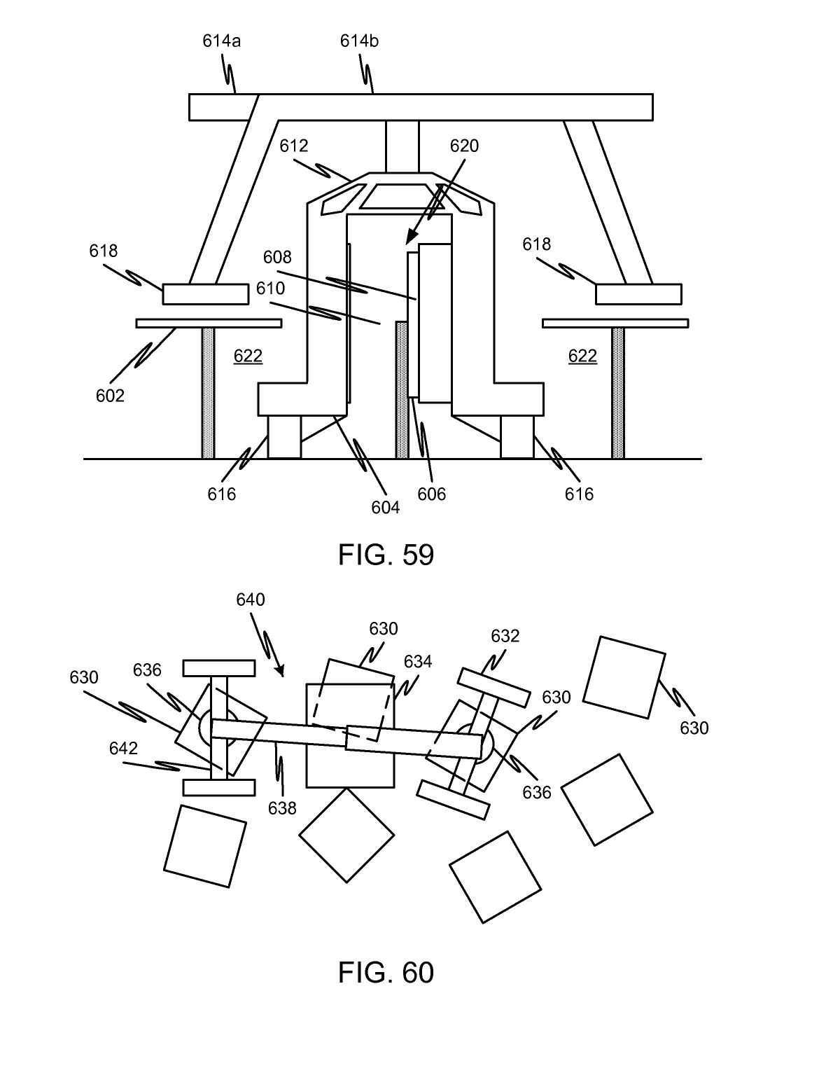

Referring to FIG. 59, a truck 612 has a centrally aligned recess 620 that allows the truck to driver over a heliostat 606 positioned in a vertical or near-vertical position. A cleaning effecter 608 may reach the heliostat 606 (a second cleaning effecter 610, shown retracted, may be provided) while extensions 614a and 614b reach out laterally to clean nearby heliostats 602 using cleaning effecters 618. A feature of the present embodiment, which may be applied to any of the embodiments described herein, is that wheels 616 may be spaced apart to extend into spaces 622 beneath adjacent heliostats to provide a wider stance. The configuration illustrated may permit the truck 612 to pass along a track nearly within the width space of a single heliostat plus a minimum spacing margin therearound while providing a wide enough stance for stability. The configuration could be expanded to have a gap 620 that surrounds multiple heliostats with cleaning effectors being positionable to clean each surrounded heliostat.

In the various embodiments above or in the claims, the vehicle or truck may be equipped with a curved cow catcher type of device to harmlessly deflect animals away from the path of wheels. The blade may have a flexible edge to permit to hug the surface. Alternatively, a proximity detector (acoustic, infrared, or other) or imaging device (laser scanner, radar, camera, etc.) and a series of jets generators may be provided on such a cow catcher (or as an alternative) to push animals away from vehicle's path. Skirts may be provided on the sides to prevent animals from moving beneath the wheels.

FIG. 60 shows an articulating vehicle that maneuvers between heliostats to wash them. The vehicle 640 has central spine 638 whose length may be changeable, in embodiments. Alternatively a fixed length chassis of any form may be used. Pivoting carriages 642 (e.g. axles) allow the wheels 632, which are spaced apart by an average distance between heliostats in a region where the vehicle operates, to be maneuvered to pass around heliostats. A cleaning portion 634 may clean heliostats in horizontal or near horizontal positions or in any other positions. The cleaning portion 634 may be positionable and orientable. The same configuration 640 may employ multiple cleaning effecters. The multiple degrees of freedom and complex control can be implemented through detection of positions of heliostats 630.

Features of the disclosed embodiments may be combined, rearranged, omitted, etc., within the scope of the present disclosure to produce additional embodiments. Furthermore, certain features may sometimes be used to advantage without a corresponding use of other features.

It is, thus, apparent that there is provided, in accordance with the present disclosure, systems and methods for arranging, maintaining, or operating heliostats within a solar field. Many alternatives, modifications, and variations are enabled by the present disclosure. While specific embodiments have been shown and described in detail to illustrate the application of the principles of the invention, it will be understood that the invention may be embodied otherwise without departing from such principles. Accordingly, Applicant intends to embrace all such alternatives, modifications, equivalents, and variations that are within the spirit and scope of the present invention.

1. A maintenance vehicle for cleaning heliostats in a solar field, the maintenance vehicle comprising:
a main body;
a translation system constructed to move the main body through the solar field; and
one or more cleaning modules, each cleaning module including at least one cleaning tool,
wherein each cleaning module is configured to position each cleaning tool proximal to a corresponding mirror surface of one of the heliostats for cleaning.

2. The maintenance vehicle according to claim 1, wherein the cleaning module includes multiple arm segments, at least one of the arm segments being moveable or telescopic.

3. The maintenance vehicle according to claim 1, wherein each cleaning module include a crane with a boom extending therefrom, the cleaning tool being moveable along a length of the boom.

4. The maintenance vehicle according to claim 1, wherein the cleaning tool is a contact cleaning tool, and the cleaning module is configured to dispose the contact cleaning tool in direct contact with the corresponding mirror surface.

5. The maintenance vehicle according to claim 1, wherein the cleaning tool is a water spraying tool, and the cleaning module is configured to dispose the spraying tool adjacent to but spaced from the corresponding mirror surface.

6. The maintenance vehicle according to claim 1, further comprising a control module configured to control operation of the maintenance vehicle, wherein the control module is configured to maneuver the maintenance vehicle between adjacent heliostats in the solar field.

7. The maintenance vehicle according to claim 6, wherein the control module is configured to control the cleaning module to position the cleaning tool proximal to a mirror surface of a buried heliostat, at least one of said adjacent heliostats being arranged between the buried heliostat and the main body of the maintenance vehicle.

8. The maintenance vehicle according to claim 6, wherein the control module is configured to maneuver the maintenance vehicle through the solar field in response to at least one of predicted animal movement, detected animal movement, predicted animal location, detected animal location, predicted animal habitat location, and detected animal habitat location.

9. The maintenance vehicle according to claim 6, wherein the control module is located on the main body, at a location within the solar field, or at a location external to the solar field.

10. The maintenance vehicle according to claim 1, wherein the translation system includes an engine, a transmission coupled to said engine, and wheels coupled to said transmission.

11. The maintenance vehicle according to claim 10, wherein each wheel is capable of being steered.

12. The maintenance vehicle according to claim 1, further comprising a driver cabin for operating the maintenance vehicle, wherein the cabin is capable of being rotated to allow an operator to face in a direction of movement of the maintenance vehicle.

13. The maintenance vehicle according to claim 1, further comprising a driver cabin for operating the maintenance vehicle, wherein the cabin includes multiple control sets, an operator using one of the control sets while facing in a first direction of movement of the maintenance vehicle and using another of the control sets while facing in another direction of movement of the maintenance vehicle.

14. The maintenance vehicle according to claim 1, further comprising a first driver cabin at an end of the maintenance vehicle for use by an operator when operating the maintenance vehicle in a first direction of movement of the maintenance vehicle, and a second driver cabin at an opposite end of the maintenance vehicle for use by the operator when operating the maintenance vehicle in a second direction of movement of the maintenance vehicle.

15. The maintenance vehicle according to claim 1, wherein the maintenance vehicle is remotely operated.

16. A method of cleaning heliostats in a solar field with a maintenance vehicle, the method comprising:
determining no-drive zones within a solar field based on at least one of predicted animal movement, detected animal movement, predicted animal location, detected animal location, predicted animal habitat location, and detected animal habitat location; and
moving the maintenance vehicle from a first location to a second location in the solar field while avoiding the determined no-drive zones; and

17. The method of claim 16, further comprising, at said second location, cleaning one or more of the heliostats.

18. The method of claim 16, wherein the no-drive zones are temporary no-drive zones based on detected or predicted animal movement.

19. The method of claim 17, wherein the moving to the second location includes pausing at a temporary no-drive zone to allow animal passage.

20. The method of claim 17, wherein the moving to the second location includes moving the maintenance vehicle along an alternate path between the first location and the second location so as to circumvent the no-drive zone.

21-62. (canceled)
